(19) United States
(12) Patent Application Publication
(10) Pub. No.: US 2025/0298763 A1
(43) Pub. Date: Sep. 25, 2025

(54) MAPPING ABSTRACT DATA MOVEMENTS INTO SEQUENTIAL AND PARALLEL DIRECT MEMORY ACCESS (DMA) PROGRAMMING

(71) Applicant: NVIDIA Corporation, Santa Clara, CA (US)

(72) Inventors: Dawid Stanislaw PAJAK, San Carlos, CA (US); Lachlan Francis DOWLING, San Jose, CA (US); Wenqi BAO, Shanghai (CN); Jinkai GAO, Shanghai (CN); Ahmad ITANI, San Jose, CA (US)

(73) Assignee: NVIDIA Corporation, Santa Clara, CA (US)

(21) Appl. No.: 18/631,701

(22) Filed: Apr. 10, 2024

(30) Foreign Application Priority Data
Mar. 20, 2024 (WO) PCT/CN2024/082789

(51) Int. Cl. G06F 13/28

(52) U.S. Cl. CPC G06F 13/28

(57) ABSTRACT

In various examples, systems and methods are disclosed relating to a system including one or more processors to generate hardware-level configurations for direct memory access (DMA) devices based on high-level descriptions of data movements. The high-level descriptions may include data flows for transferring data using the DMA device and the system may automatically generate the hardware-level configurations for the DMA device based on the data flows, simplifying the process of programming data movements and reducing the opportunity for human error.

### CROSS-REFERENCE TO RELATED APPLICATIONS

The present application claims priority to International Application No. PCT/CN2024/082789, filed Mar. 20, 2024, the disclosure of which is incorporated herein by reference in its entirety.

### BACKGROUND

High-performance computing accelerators have become indispensable tools for demanding computational tasks across scientific, graphics, and machine learning domains. These accelerators are diverse, but one thing they have in common is high latency to main memory. To harness the raw power of these devices, Direct Memory Access (DMA) engines are employed to overlap memory access latency with data processing. DMA engines are capable of multi-dimensional looping and intricate sequencing of data movement between various memory hierarchies. As a result, these engines allow efficient parallelization and optimization of data access patterns, essential for ensuring peak accelerator performance. However, the software landscape for programming these DMA engines remains complex. The programmer often must grapple with low-level, hardware-specific details, making the process more challenging, error-prone, time-consuming, and often incompatible with different, future generations of the same chip. Moreover, the results often suffer from performance and functional bugs.

### SUMMARY

Approaches in accordance with various embodiments can address limitations in existing methods of programming direct memory access (DMA) data movements. In particular, various embodiments can provide for automatic generation of DMA data movements. Conventional systems for coding DMA data movements rely upon manual coding of hardware-level data flows and manual optimization of data flows. This approach requires detailed knowledge of hardware-specific characteristics, is highly labor-intensive, and results in code for data movements that is hardware-specific and prone to human error. As a result, these prior approaches require teams of programmers that are familiar with hardware-specific details and can program low-level, hardware-level code.

The present disclosure relates to systems, methods, applications, processors, and non-transitory computer-readable media for receiving high-level, hardware-generic data flow instructions and associated parameters and automatically generating low-level, hardware-specific code for DMA data movements. A DMA compiler may receive user input regarding DMA data flows, associations of the data flows with DMA phases, and sequential linking of the data flows and output hardware-level representations of the data movement including optimized bandwidth allocation for the DMA phases.

Aspects of the present disclosure are directed to a system, including one or more processors to receive one or more data flows describing a direct memory access (DMA) data movement for transferring data using a DMA device, generating, based at least on the one or more data flows, a hardware-level configuration of a hardware of the DMA device for the one or more data flows, and transmitting the hardware-level configuration to the DMA device for execution of the DMA data movement.

In some implementations, generating the hardware-level configuration includes generating, based at least on the one or more data flows, an intermediate configuration, and generating, based at least on the intermediate configuration, the hardware-level configuration. In some implementations, generating the hardware-level configuration includes allocating hardware resources of the DMA device for the one or more data flows. In some implementations, allocating hardware resources includes allocating input buffer bandwidth and output buffer bandwidth for the one or more data flows. In some implementations, generating the hardware-level configuration includes optimizing usage of a bandwidth of the DMA device. In some implementations, the one or more data flows include phase descriptors for phases of the DMA data movement. In some implementations, the one or more data flows include links corresponding to sequential execution of the one or more data flows. In some implementations, the one or more data flows include a prioritization of the one or more data flows. In some implementations, the received one or more data flows each include a source and a destination, and wherein the one or more circuits are to determine one or more of phases for the one or more data flows and links for the one or more data flows between the one or more phases.

In some implementations, the one or more processors are to receive one or more second data flows describing a second DMA data movement for transferring data using a second DMA device, generate, based at least on the one or more second data flows, a second hardware-level configuration for the one or more second data flows, wherein the second hardware-level configuration corresponds to a hardware of the second DMA device, and transmit the second hardware-level configuration to the second DMA device for execution of the second DMA data movement.

In some implementations, the one or more processors are included in at least one of a control system for an autonomous or semi-autonomous machine, a perception system for an autonomous or semi-autonomous machine, a system implemented using a robot, an aerial system, a medical system, a boating system, a smart area monitoring system, a system for performing deep learning operations, a system for performing simulation operations, a system for generating or presenting virtual reality (VR) content, augmented reality (AR) content, or mixed reality (MR) content, a system for performing digital twin operations, a system implemented using an edge device, a system incorporating one or more virtual machines (VMs), a system for generating synthetic data, a system implemented at least partially in a data center, a system for performing conversational artificial intelligence (AI) operations, a system for performing generative AI operations, a system implementing language models, a system implementing large language models (LLMs), a system for hosting one or more real-time streaming applications, a system for performing light transport simulation, a system for performing collaborative content creation for 3D assets, or a system implemented at least partially using cloud computing resources.

Aspects of the present disclosure are directed to a method including receiving, by one or more processors, one or more data flows describing a direct memory access (DMA) data movement for transferring data using a DMA device, generating, by the one or more processors, based at least on the one or more data flows, a hardware-level configuration of a hardware of the DMA device for the one or more data flows, and transmitting, by the one or more processors, the hardware-level configuration to the DMA device for execution of the DMA data movement.

In some implementations, generating the hardware-level configuration includes generating, based at least on the one or more data flows, an intermediate configuration and generating, based at least on the intermediate configuration, the hardware-level configuration. In some implementations, generating the hardware-level configuration includes allocating hardware resources of the DMA device for the one or more data flows. In some implementations, allocating hardware resources includes allocating input buffer bandwidth and output buffer bandwidth for the one or more data flows. In some implementations, generating the hardware-level configuration includes optimizing usage of a bandwidth of the DMA device. In some implementations, the one or more data flows include phase descriptors for phases of the DMA data movement. In some implementations, the one or more data flows include links corresponding to sequential execution of the one or more data flows. In some implementations, the one or more data flows include a prioritization of the one or more data flows. In some implementations, the received one or more data flows each include a source and a destination, and wherein the one or more circuits are to determine one or more of phases for the one or more data flows and links for the one or more data flows between the one or more phases.

In some implementations, the method includes receiving, by the one or more processors, one or more second data flows describing a second DMA data movement for transferring data using a second DMA device, generating, by the one or more processors, based at least on the one or more second data flows, a second hardware-level configuration for the one or more second data flows, wherein the second hardware-level configuration corresponds to a hardware of the second DMA device, and transmitting, by the one or more processors, the second hardware-level configuration to the second DMA device for execution of the second DMA data movement.

Aspects of the present disclosure are directed to a system on a chip including one or more DMA systems and one or more processors to receive one or more data flows describing a direct memory access (DMA) data movement for transferring data using the one or more DMA systems, generate, based at least on the one or more data flows, a hardware-level configuration of a hardware of the one or more DMA systems for the one or more data flows, and transmit the hardware-level configuration to the one or more DMA systems for execution of the DMA data movement.

### BRIEF DESCRIPTION OF THE DRAWINGS

Embodiments discussed herein are described in detail below with reference to the attached drawing figures, wherein:

FIG. 1 is a block diagram of an example system, in accordance with at least some embodiments of the present disclosure;

FIG. 2 depicts an example data movement generated using the system of FIG. 1, in accordance with at least some embodiments of the present disclosure;

FIG. 3 depicts an example implementation of data movements for sequential tiled access of two-dimensional (2D) images, in accordance with at least some embodiments of the present disclosure;

FIG. 4 depicts an example implementation of data movements for parallel scatter/gather of data, in accordance with at least some embodiments of the present disclosure;

FIG. 5 depicts an example implementation of data movements for sequential scatter/gather of data, in accordance with at least some embodiments of the present disclosure;

FIG. 6 depicts an example data flow initialization and configuration method, in accordance with at least some embodiments of the present disclosure;

FIGS. 7A-7C depict an example data flow compilation method, in accordance with at least some embodiments of the present disclosure;

FIG. 8 depicts an example data flow update method, in accordance with at least some embodiments of the present disclosure;

FIG. 9 depicts an example parallel gather/scatter data flow implementation method, in accordance with at least some embodiments of the present disclosure;

FIG. 10 depicts an example sequential gather/scatter data flow implementation method, in accordance with at least some embodiments of the present disclosure;

FIG. 11 depicts an example method for implementation of a data flow for sequential tiled access of 2D images, in accordance with at least some embodiments of the present disclosure;

FIG. 12 is a flow chart of an example method for generating DMA movements based on data flows, in accordance with at least some embodiments of the present disclosure.

FIG. 13 illustrates an example data center, in accordance with at least some embodiments of the present disclosure.

FIG. 14 is a block diagram of an example computing device, in accordance with at least some embodiments of the present disclosure.

FIG. 15A is an illustration of an example autonomous vehicle, in accordance with some embodiments of the present disclosure.

FIG. 15B is an example of camera locations and fields of view for the example autonomous vehicle of FIG. 15A, in accordance with some embodiments of the present disclosure.

FIG. 15C is a block diagram of an example system architecture for the example autonomous vehicle of FIG. 15A, in accordance with some embodiments of the present disclosure.

FIG. 15D is a system diagram for communication between cloud-based server(s) and the example autonomous vehicle of FIG. 15A, in accordance with some embodiments of the present disclosure.

### DETAILED DESCRIPTION

Systems and methods are disclosed related to mapping abstract data movements to hardware-specific commands.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, generative AI applications, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implementing one or more language models—such as one or more large language models (LLMs), systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

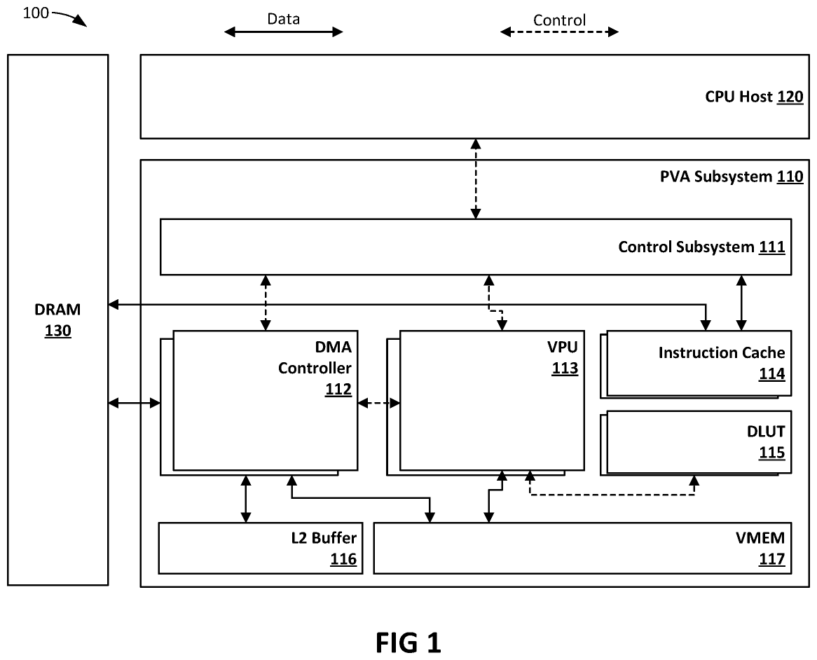

FIG. 1 is a block diagram of an example system 100, in accordance with at least some embodiments of the present disclosure. The system 100 may include a programmable vision accelerator (PVA) subsystem 110, a CPU host 120, and dynamic random access memory (DRAM). The PVA subsystem 110 may perform image perception tasks, digital signal processing tasks, and/or other tasks which require moving large amounts of image data from a source location to a target location.

The PVA subsystem 110 may include a control subsystem 111, one or more DMA controllers 112, one or more vector processing units (VPUs) 113, one or more instruction caches 114, one or more decoupled lookup tables (DLUTs) 115, vector memory 117, and/or other components. In some implementations, the PVA subsystem 110 includes a level 2 (L2) buffer 116. The L2 buffer may be a dedicated buffer for the one or more DMA controllers 112.

The control subsystem 111 may receive commands from the CPU host 120 related to image perception tasks. The control subsystem 111 may send commands to the one or more DMA controllers 112 and the one or more VPUs 113. The control subsystem 111 may send coordinated commands to the one or more DMA controllers 112 and the one or more VPUs 113 for performing image perception tasks. The one or more VPUs 113 may each include a DMA engine, allowing the VPU to access the DRAM 130 independent of the CPU host 120. The DMA engine may also be referred to as a DMA device, or DMA system. Each DMA engine may have multiple DMA channels. In an example, each DMA engine includes 16 channels. Each DMA channel can independently (and concurrently with respect to other DMA channels) execute a sequential linked list of transfers, where each transfer can contain up to five nested data movements loops, can perform automatic data padding (to, for example, implement boundary condition in 2D data movements) and can be triggered at various looping dimensions.

The DMA channels may work in parallel and share input/output buffers to memory interfaces, such as the DRAM 130 and/or the VMEM 117. An example of input buffers and output buffers may be referred AXI data buffers (ADBs) and VMEM data buffers (VDBs). Buffer allocation (e.g., ADB and VDB allocation) may be static and directly translates to memory bandwidth available to each DMA channel. Thus, a programmer who is manually programming a data movement is forced to solve a complex optimization problem as to how much bandwidth to allocate to each channel working concurrently and when and/or how to safely alias buffer resources (e.g., ADB/VDB resources) between channels.

The one or more DMA controllers 112 may control the DMA engines to perform data movements. The one or more DMA controllers 112 may receive commands from the control subsystem 111 for controlling the DMA engines 112. In some implementations, the control subsystem 111 may generate hardware-specific commands based on higher-level instructions received from the CPU host 120, as discussed herein. In some implementations, the CPU host 120 makes an API call to the control subsystem 111 which translates the API call to device code for execution by the DMA channels.

The VMEM 117 may be memory dedicated to the PVA subsystem 110. The one or more VPUs 113 and/or the one or more DMA controllers 112 may create one or more buffers within the VMEM 117. The one or more VPUs 113 and/or the one or more DMA controllers 112 may move data into and out of one or more buffers within the VMEM 117, such as discussed herein.

The DLUT 115 may support multiple modes for performing table lookups, such as a 1D lookup mode, a 2D lookup mode, a 2D conflict free lookup mode, a 1D lookup with interpolation mode, a 2D lookup with interpolation mode, a table reformatting mode, and/or other modes. In any lookup mode, the DLUT 115 may accept an array of indices in the VMEM 117, which may be in 1D (x) format or 2D (x, y) format. Each element may include 16 bits or 32 bits, for example, which may be unsigned. The DLUT 115 may then perform a prescribed index calculation, which may include 2D to 1D mapping, truncate/round, integer/fraction split, and/or valid range detection, as non-limiting examples. For example, the DLUT may detect or consolidate duplicate reads, detect bank conflicts within indices, and issue read requests to the VMEM 117 to look up the requested table entries. Each element may include 8 bits, 16 bits, or 32 bits, which may be either signed or unsigned. The DLUT may then perform interpolation post-processing as configured and may write the output back to VMEM. Each of these processing operations may be executed in a pipeline to increase throughput, reduce latency, and reduce power consumption. As a result, the DLUT 115 overcomes the deficiencies of implementing dynamic conflict detection and resolution in the processor pipeline, allowing for efficient scheduling of deterministic execution latencies for all memory operations while avoiding the complexity to do conflict detection in line.

The instruction cache 114 may cache instructions for the one or more VPUs 113 to execute. In some implementations, the instructions cache 114 is part of the one or more VPUs 113. In some implementations, each of the one or more VPUs 113 includes an instructions cache 114.

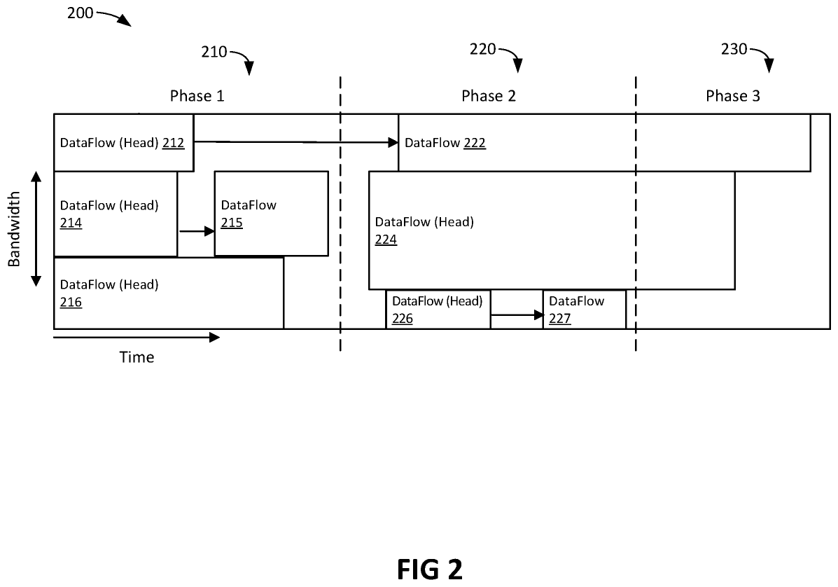

FIG. 2 depicts an example data movement 200 generated using the system of FIG. 1, in accordance with at least some embodiments of the present disclosure. In some implementations, the data movement is generated by the control subsystem 111 based on high-level instructions in an API call from the host CPU 120 of FIG. 2.

The data movement 200 may include a first phase 210, a second phase 220, and a third phase 230. The first phase 210, the second phase 220, and the third phase 230 may be sequential phases of the data movement 200. Although the data movement 200 is illustrated as including three phases, the data movement may include any number of phases.

The data movement 200 may include hardware-level commands for implementing the data movement 200 which were generated based on a set of high-level abstractions provided by a user. In an example, a user describes data flows describing data transfer operations such as random scatter/gather data flow (GSDF), sequential block data flow (SQDF), and raster-scan data flow (RDF) 2D tile transfers. The data flows may be included in APIs which are received by a DMA compiler. The DMA compiler may translate the data flows into low-level (e.g., hardware-level) DMA programs. In some implementations, the DMA compiler may be an algorithm executed by the control subsystem 111 of FIG. 1.

The DMA compiler may receive user input describing the data flows. The user input may be received via an API call from a CPU host. The user input may include characteristics of the data flows such as a number of the data flows, types of data flows in the data flows, transfer sizes per VPU/DMA handshake, concurrency in the data movement graph, and/or phases of the DMA movement during which the data flows are to be performed. In some implementations, the user input includes weights for the data flows which describe relative priorities between the data flows for bandwidth allocation. In some implementations, the user input includes aliasing, describing which data flows within a phase should use the same hardware resources. In an example, the user input specifies a source address, a destination address, a transfer size, a boundary condition, and a VPU handshake granularity for the data movement 200. In an example, the user input includes sequential linking of the data flows and associations of the data flows with phases of the data movement 200.

In some implementations, the DMA compiler receives the characteristics of the data flows from a high-level compiler which extracts the data flow characteristics from the user input and/or from program source code. In an example, the user input specifies a source and destination for the data flows and the high-level compiler determines the phases and links for the data flows. In an example, the program source code specifies a movement of data from a source to a destination and the high-level compiler determines the phases and links for the data flows. In an example, the high-level compiler infers the data movement from the program source code and generates descriptions of the data flows for the inferred data movement.

The DMA compiler may, in response to the data describing the data flows (e.g., user input, high-level compiler input), automatically allocate DMA hardware resources to the data flows. The DMA hardware resources may include DMA channels, triggers, input buffers and output buffers (e.g., ADBs and VDBs), and/or DMA descriptors. DMA triggers may be used to signal a DMA engine during the data movement to start a tile transfer. In an example, a DMA trigger may be used to trigger a DMA engine to transfer data from a buffer once the buffer contains the data to be transferred. The DMA descriptors may be low-level descriptions of the data flows.

The DMA compiler may automatically allocate the DMA hardware resources based on the user input describing the data flows. The DMA compiler may allocate the DMA hardware resources based on the characteristics of the data flows. Allocating the DMA hardware resources may include optimizing bandwidth allocation (e.g., allocation of buffers such as ADBs and VDBs) for each channel. Given a fixed bandwidth, the DMA compiler may determine how much bandwidth to allocate to each channel and/or data flow.

As shown in FIG. 2, the DMA compiler may allocate the bandwidth of input and output buffers (e.g., ADBs and VDBs) to a first data flow head 212, a second data flow head 214, a second data flow tail 215, and a third data flow head 216 in the first phase 210. The first data flow head 212 may be linked to a first data flow tail 222 in the second phase 220 and the third phase 230. The first data flow head 212 may be linked to the first data flow tail 222 based on the user input specifying that the first data flow head 212 is sequentially linked to the first data flow tail 222. The second data flow head 214 may be linked to the second data flow tail 215 in the first phase 210 based on the user input specifying that the second data flow head 214 and the second data flow tail 215 are sequentially linked and in the first phase 210.

The DMA compiler may allocate the bandwidth in the second phase 220 between the first data flow tail 222, a fourth data flow head 224, a fifth data flow head 226, and a fifth data flow tail 227. The fifth data flow head 226 and the fifth data flow tail 227 may be in the second phase 220 based on the user input specifying that the fifth data flow head 226 and the fifth data flow tail 227 are sequentially linked and in the second phase 220. The DMA compiler may allocate the bandwidth in the third phase 230 between the first data flow tail 222 and the fourth data flow head 224.

Without the DMA compiler, a programmer would have to manually allocate the bandwidth between the data flows and program the individual data flows with the allocated bandwidth. By automatically allocating and optimizing the bandwidth between the data flows, the DMA compiler increases an efficiency of programming data movements and reduces a number of bugs introduced due to programmer error. In some implementations, the DMA compiler increases an efficiency of the data movement 200 by maximizing use of the bandwidth.

In some implementations, the DMA compiler may compile DMA hardware sequencer bytecode for the data movement 200. The hardware sequencer is specialized hardware to control sequencing and re-sequencing descriptors on DMA channels. The hardware sequencer may be programmed with the hardware sequencer bytecode. The hardware sequencer may determine sequencing of descriptors when a sequencing order is not specified. In an example, the hardware sequencer controls sequencing descriptors based on the hardware sequencer bytecode in response to links between data flows not being specified in descriptions of the data flows. In another example, the hardware sequencer is not used based on links between data flows being specified in descriptions of the data flows. The DMA compiler may automatically determine whether the hardware sequencer is used. In an example, the DMA compiler determines whether descriptions of the data flows include links between the data flows and compiles the hardware sequencer bytecode for the hardware sequencer based on links not being included in the descriptions of the data flows. The DMA compiler may compile, based on the allocated DMA hardware resources, the DMA hardware sequencer bytecode for the DMA hardware to implement the data movement 200. In this way, the DMA compiler translates high-level user input describing data flows of the data movement 200 to hardware-level commands for performing the data movement 200.

The data movement 200 illustrated in FIG. 2 is a high-level representation of the data movement and the allocation of the bandwidth across the different data flows of the data movement 200 in the different phases of the data movement 200. The DMA compiler may automatically generate the data movement 200 based on user input describing the sequential linking of the data flows and associations between the data flows and the phases of the data movement 200. The data movement 200 output by the DMA compiler may include mutually exclusive and shared allocation of the bandwidth, a hardware-level representation (e.g., bytecode) of the data movement 200, and metadata for a VPU to interact with the data flows. In this way, the risk of bugs and errors which may be introduced by human programming of hardware-level commands is mitigated. Additionally, by automatically compiling the hardware-level commands, the DMA compiler insulates the user input from future hardware changes. User input including high-level descriptions of data flows does not need to change, as the DMA compiler can generate, based on the high-level descriptions of data flows, hardware-level commands for different hardware. By updating the DMA compiler with hardware updates, the user is insulated from changing their descriptions of data flows in response to the hardware updates.

In some implementations, buffer addresses for the buffers (e.g., source and destination data buffers in system memory) may be placeholders for buffers which will change at runtime. The buffer address may be offset pointers which encode a fixed offset from a variable base address. This allows for updating the base address of the offset pointers when the DMA compiler is generating the data movement 200. In this way, the change to the buffer address propagates to the data movement 200 without requiring a full recompilation of the data flows. In an example, a camera processing application uses the data movement 200 to process images having different addresses, where the buffer address is updated to the addresses of subsequent images for processing multiple images using the data movement 200.

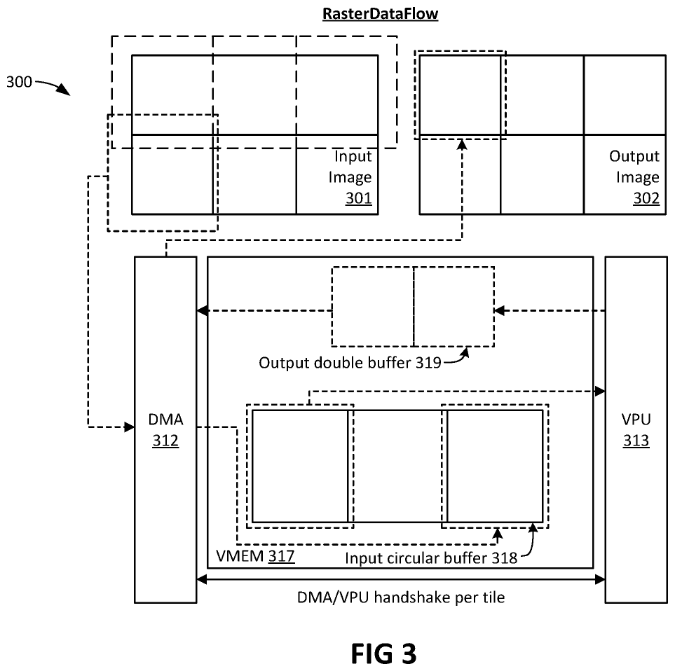

FIG. 3 depicts an example implementation of a data flow 300 for sequential tiled access of 2D images, in accordance with at least some embodiments of the present disclosure. The data flow 300 may be a raster data flow. The data flow 300 may be generated by a DMA compiler and allocated hardware resources, as discussed in conjunction with FIG. 2.

The data flow 300 may allow for pipelining data movement with data processing. The data flow 300 may be hardware accelerated using dedicated hardware within a DMA 312. The data flow 300 may support tile overlap for convolution-style use cases, region of interest, and out-of-bounds access handled by hardware.

The DMA 312 may retrieve a tile of an input image 301 and place the tile in a circular input buffer 318 in a VMEM 317. A VPU 313 may retrieve the tile from the circular input buffer 318 and process the tile. The VPU 313 may place the processed tile in an output double buffer 319 in the VMEM 317. The DMA 312 may retrieve the processed tile from the output double buffer 319 and place it in an output image 302. In this way, data is moved from the input image 301 to the output image 302 by the DMA 312 while being processed by the VPU 313. The actions of the DMA 312 and the VPU 313 need to be coordinated for proper movement and processing of tiles. In an example, the DMA 312 and the VPU 313 perform a handshake for each tile which is transferred and processed. In some implementations, the input image 301 and the output image 302 are in buffers of DRAM. In some implementations, the tiles may be accessed in a random order from the input image 301 and placed in a random order in the output image 302.

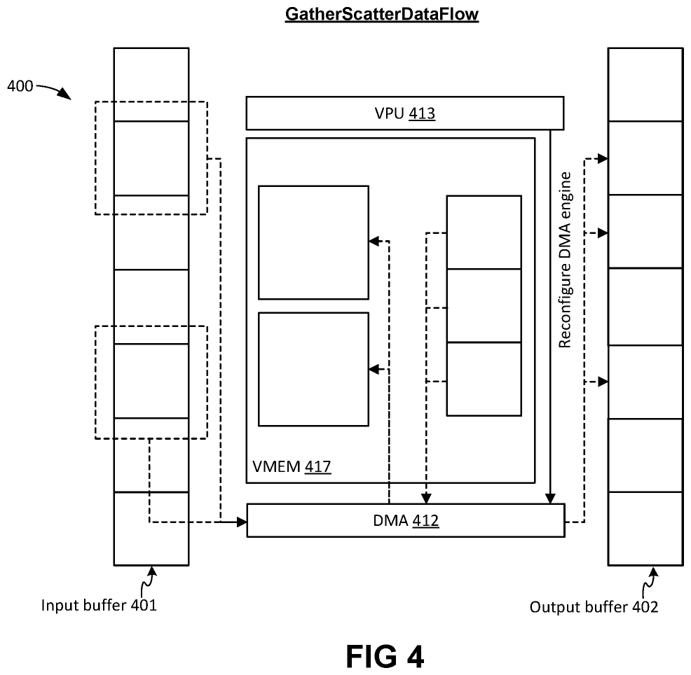

FIG. 4 depicts an example implementation of a data flow 400 for parallel scatter/gather of data, in accordance with at least some embodiments of the present disclosure. The data flow 400 may be a gather/scatter data flow. The data flow 400 may be generated by a DMA compiler and allocated hardware resources, as discussed in conjunction with FIG. 2.

The data flow 400 may allow for a parallel gather/scatter of data. The data flow 400 may be hardware accelerated using dedicated hardware within a DMA 412. The data flow 400 may be optimized for random access in 2D surfaces. The data flow 400 may support multiple transfers per request. In an example, the data flow 400 may support up to 32 transfers per request. The data flow 400 may include a shared abstraction spanning a host and a device including the DMA 412 and a VPU 413.

The DMA 412 may retrieve, from an input buffer 401, multiple tiles in parallel and place the multiple tiles in a VMEM 417. The DMA 412 may retrieve multiple tiles from the VMEM 417 and place the multiple tiles in an output buffer 402. The VPU 413 may reconfigure the DMA 412 to adjust how the DMA 412 transfers tiles to and from the VMEM 417. In an example, the VPU 413 reconfigures the DMA 412 based on instructions generated by the DMA compiler.

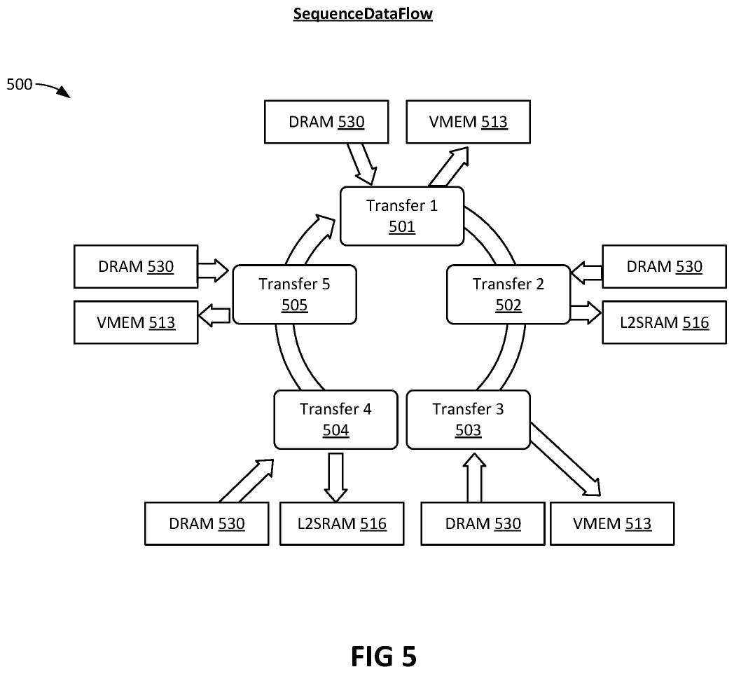

FIG. 5 depicts an example implementation of a data flow 400 for sequential scatter/gather of data, in accordance with at least some embodiments of the present disclosure. The data flow 400 may be a gather/scatter data flow. The data flow 400 may be generated by a DMA compiler and allocated hardware resources, as discussed in conjunction with FIG. 2.

The data flow 500 may allow for a sequential gather/scatter of data. The data flow 500 may allow for coarser synchronization of a DMA and VPU than the data flow 400 of FIG. 4. The data flow 500 may support arbitrary numbers of copies. The data flow 400 may be useful for bulk data copies. The data flow 500 may include a shared abstraction spanning a host and a device including a DMA and a VPU.

The data flow 500 may include a first transfer 501 from a DRAM 512 to a VMEM 513. The data flow 500 may include a second transfer 502 from the DRAM 530 to a level 2 static random access memory (L2SRAM) 516. The data flow 500 may include a third transfer 503 from the DRAM 512 to the VMEM 513. The data flow 500 may include a fourth transfer 504 from the DRAM 530 to the L2SRAM 516. The data flow 500 may include a fifth transfer 505 from the DRAM 530 to the VMEM 513. The data flow 500 may continue with repeated transfers. In some implementations, the data flow 500 repeats cyclically from the fifth transfer 505 to the first transfer 501 and so on.

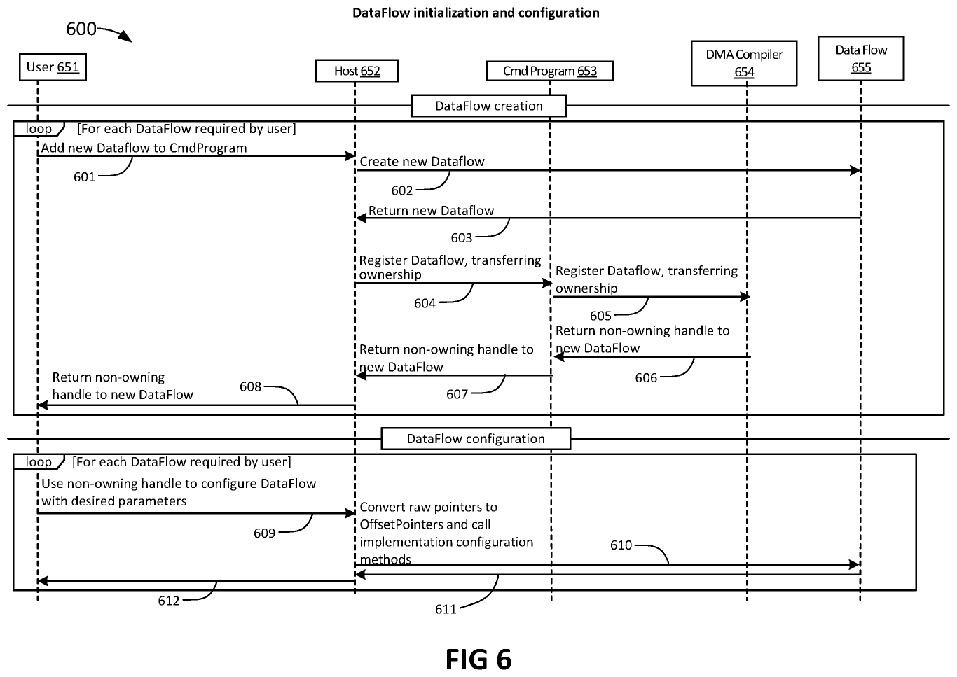

FIG. 6 depicts an example data flow initialization and configuration method 600, in accordance with at least some embodiments of the present disclosure. The method 600 is described as initializing and configuring data flows at runtime, but can be performed offline or partially offline. The method 600 may initialize data flows without requiring hardware details. In this way, the user-provided code is simplified and can be extended to different hardware. In addition, the method 600 may be performed to initialize data flows prior to runtime, saving configuration time on the device side. The method 600 may include more, fewer, or different operations than shown. The operations may be performed in the order shown, in a different order, or concurrently.

At operation 601, a user 651 adds inputs a new data flow to a host 652 to add the data flow to a command program 653. The host 652 may be a host API unit. In an example, the host 652 is a host C or C++ API unit. At operation 602, the host 652 creates the new data flow 655 as a base data flow. In some implementations, the data flow 655 may be a base data flow such as a static data flow or a configuration data flow. In some implementations, the data flow 655 is a custom data flow such as a raster data flow, a gather/scatter data flow, a dynamic data flow, or a sequence data flow, as discussed herein. In some implementations, the custom data flows include one or more base data flows. At operation 603, the data flow 603 returns the data flow 603, or a status of the data flow 603. At operation 604, the host 652 registers the data flow 655 with the command program 653, transferring ownership to the command program 653. The command program 653 may be a unit of work which can be submitted to a PVA (e.g., the PVA subsystem 110 of FIG. 1), combining an asynchronous DMA configuration with a data processing program to be executed by a VPU (e.g., one or more VPUs 113 of FIG. 1). When the PVA executes the command program 653, the VPU signals a DMA when the DMA should proceed with a next stage of a transfer.

At operation 605, the command program 653 registers the data flow 655 with a DMA compiler 654, transferring ownership of the data flow 655 to the DMA compiler 654. The DMA compiler may be an algorithm or process which can translate the data flow 655 from abstract, high-level descriptions into optimized, low-level (e.g., hardware-level) DMA programs, as discussed herein. At operation 606, the DMA compiler 654 returns a non-owning handle corresponding to the data flow 655 to the command program 653. At operation 607, the command program 653 returns the non-owning handle corresponding to the data flow 655 to the host 652. At operation 608, the host 652 returns the non-owning handle corresponding to the data flow 655 to the user 651.

The operations 601-608 may be repeated for multiple data flows. In an example, the operations 601-608 are repeated for each data flow added by the user 651. The operations 601-608 may be termed a “data flow creation stage.”

At operation 609, the user 651 uses the non-owning handle corresponding to the data flow 655 at the host 652 to configure the data flow 655 with desired parameters which are input to the host 652. At operation 610, the host 652 calls implementation configuration methods. The implementation configuration methods applied are based on a type of the data flow 655. In an example, different implementation configuration methods may be applied for raster data flows, for gather/scatter data flows, and sequence data flows. Some implementations, the host 652 converts raw pointers of the data flow 655 to offset pointers. At operation 611, the configured data flow 655 is returned to the host 652, or confirmation of the configuration of the data flow 655 is returned to the host 652, which passes configured data flow 655 or the confirmation of the configuration of the data flow 655 to the user 651 at operation 612.

The operations 609-612 may be repeated for multiple data flows. In an example, the operations 609-612 are repeated for each data flow added by the user 651. The operations 609-612 may be termed a “data flow configuration stage.”

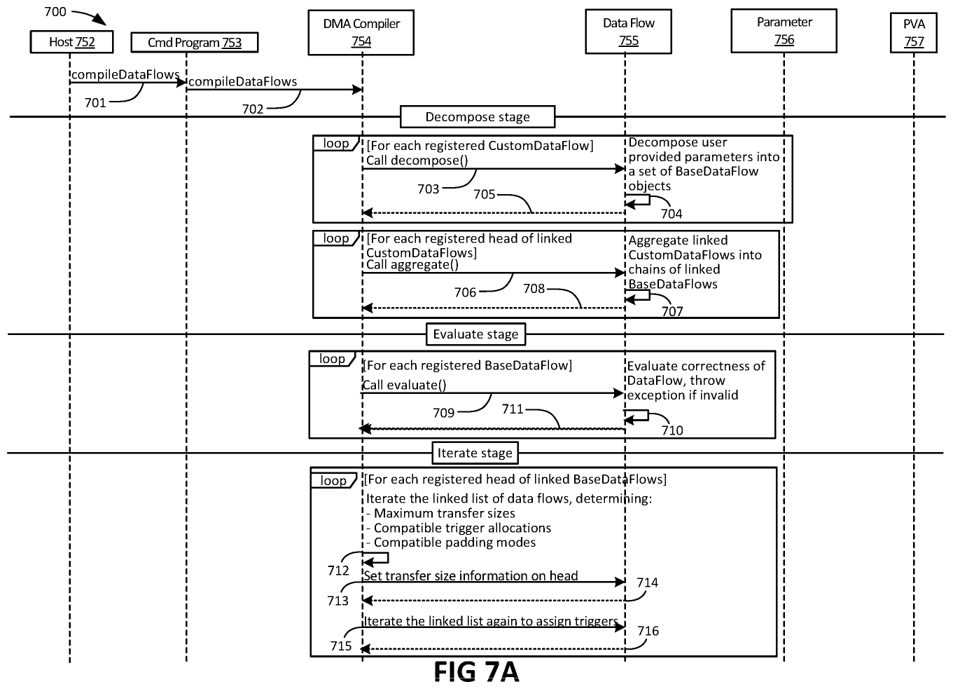

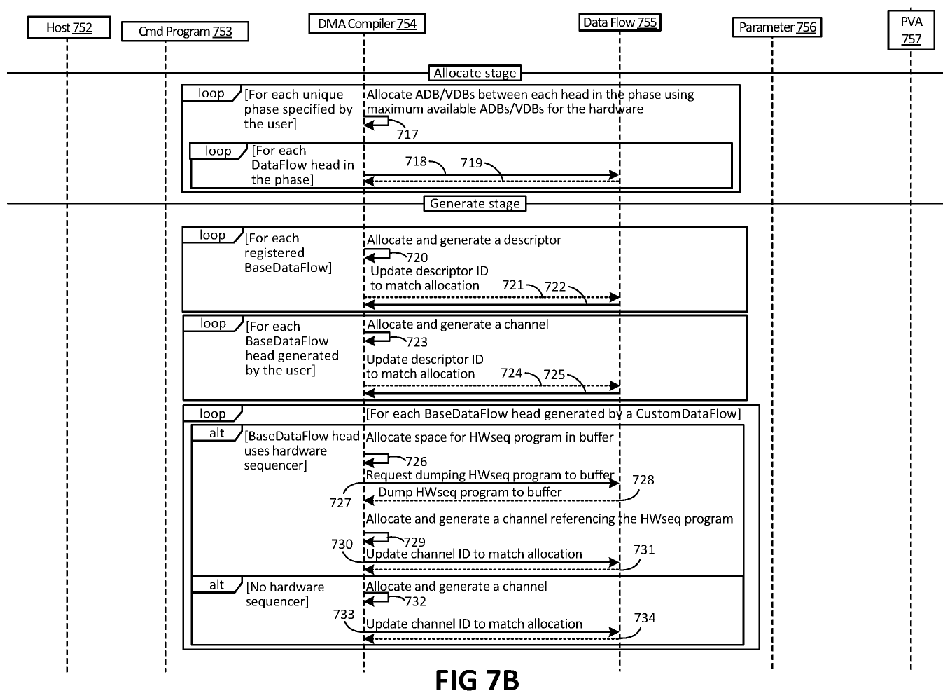

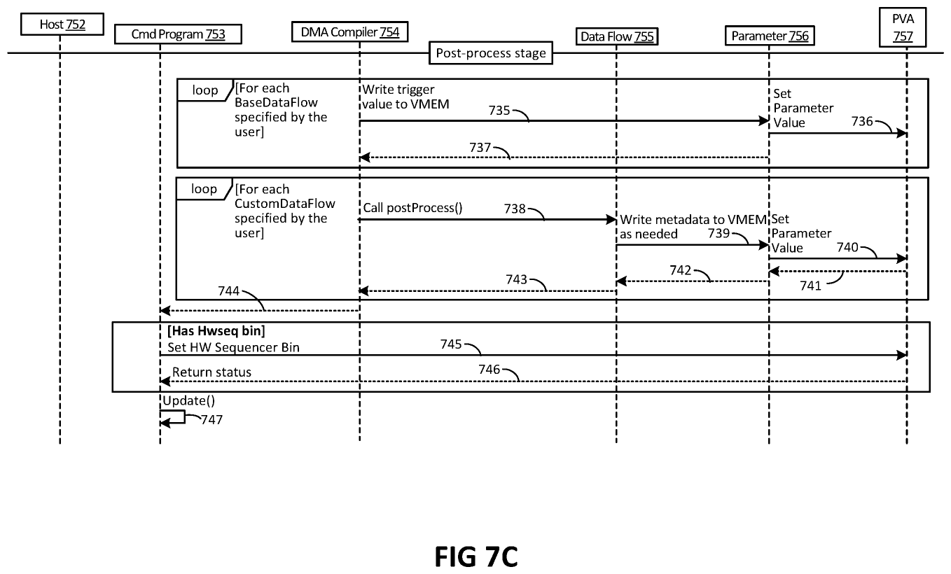

FIGS. 7A-7C depict an example data flow compilation method 700, in accordance with at least some embodiments of the present disclosure. The method 700 may be performed to compile data flows (such as the data flow 655 of FIG. 6) to a hardware specification. The method 700 may be performed to compile created and configured data flows. Once a user has created data flows, the user can request that the data flows be compiled to a hardware specification associated with a command program to cause a DMA engine to execute the data flows. A DMA compiler may first call decompose routines to generate lower-level objects which map to DMA descriptors and hardware sequencer objects from the user-specified data flows. A decompose routine may be specific to a type of data flow. In an example, a raster data flow may be associated with specific decompose routines for generating lower-level objects from the user-specified raster data flow. The DMA compiler may apply optimization and/or allocation stages to the resulting objects to arrive at a final hardware configuration for use by the DMA engine. In some implementations, the DMA engine uses the hardware configuration at runtime.

By first decomposing the data flows to basic, low-level abstractions, and applying optimization and bandwidth allocation to the low-level abstractions, the method 700 can be applied to arbitrary data movements (e.g., tensors, voxels, etc.). In an example, the data flows specified by the user include custom data flows (i.e., higher-level data flows) and base data flows (i.e., low-level data flows). The user-specified custom data flows can be decomposed to base data flows, and then the base data flows (both user specified and generated from the custom data flows) are translated into hardware-level instructions.

The compilation of the data flow performed in the method 700 also generates a data flow trigger which is used to signal the DMA channels during runtime. The method 700 may be performed to compile data flows prior to runtime, saving time on the device side. The method 700 may include more, fewer, or different operations than shown. The operations may be performed in the order shown, in a different order, or concurrently.

At operation 701, a host 752 calls a function to a command program 753 to compile a data flow 755 which was previously initialized and configured. A user may provide input to the host 752 to call the function. The data flow 755 may have been initialized and configured according to the method 600 of FIG. 6. At operation 702, the command program 753 passes the function to a DMA compiler 754. The host 752, the command program 753, and the DMA compiler 754 may correspond to the host 652, the command program 653, and the DMA compiler 654, respectively.

At operation 703, the DMA compiler 754 calls a decompose function to decompose the data flow 755 into a set of base data flow objects. The base data flow objects may be low-level abstractions of the data flow 755 described by the user and may map closely to DMA descriptors and hardware sequencer objects. The data flow 755 may be a custom data flow corresponding to a set of base data flow objects. At operation 704, the data flow 755 is decomposed from user-specified parameters into the base data flow objects. At operation 705, the DMA compiler 754 confirms the decomposition of the data flow 755.

Operations 703-705 may be repeated for each registered data flow specified by the user and then initialized and configured. In this way, each data flow specified by the user is decomposed into a set of base data flow objects.

At operation 706, the DMA compiler 754 calls an aggregate function to aggregate the base data flow objects into chains of linked base data flow objects according to links between data flows specified by the user. The user may include the links between the data flows when the user describes the data flows. By calling the aggregate function, the base data flow objects follow the structure of links between data flows specified by the user. At operation 707, the data flow 755, comprising base data flow objects, is linked with other base data flow objects according to the structure of links between data flows specified by the user. In an example, the user specifies that a first data flow is sequentially linked to a second data flow. When the first data flow and the second data flow are decomposed into first base data flow objects and second base data flow objects, the aggregate function links the first base data flow objects and second base data flow objects such that the first base data flow objects and second base data flow objects are sequentially linked according to the sequential link between the first data flow and the second data flow as specified by the user. At operation 708, the DMA compiler confirms the aggregation of the base data flow objects.

Operations 706-708 may be repeated for each registered head of linked data flows. In this way, each chain of data flows specified by the user is accounted for such that the base data flow objects are linked according to the links specified by the user for the data flows.

Operations 703-708 may be termed a “decompose stage,” as the operations 703-708 result in chains of base data flow objects from decomposed user-specified data flows.

At operation 709, the DMA compiler calls an evaluate function to evaluate the data flow 755. At operation 710, the DMA compiler determines whether the data flow 755 is correct (e.g., correctly decomposed, correctly linked) and either confirms that the data flow 755 is correct or throws an exception. At operation 711, the DMA compiler confirms the status of the data flow 755 as correct or not correct. Operations 709-711 may be repeated for each registered data flow and each base data flow object generated in the decompose stage. In this way, each data flow and each base data flow object is evaluated for correctness. Operations 709-711 may be termed an “evaluate stage.”

At operation 712, the DMA compiler 754 determines, for a linked list of base data flow objects, a maximum transfer size, compatible DMA trigger allocations, and compatible padding modes. At operation 713, the DMA compiler 754 sets transfer size information in the head of the linked list of data flows and confirms the transfer size information is set at operation 714. At operation 715, the DMA compiler 754 iterates over the linked list to assign triggers to the base data flow objects in the linked list.

Operations 712-716 may be repeated for each registered head of linked base data flow objects. In this way, each chain of linked base data flow objects may be iterated over to set the transfer size information and assign triggers for the chain. Operations 712-716 may be termed an “iterate stage.”

At operation 717, the DMA compiler 754 may allocate input and output buffers (e.g., ADBs and VDBs) between each head in a phase. The head of a linked chain of base data flow objects may be in the phase, while other base data flow objects in the chain may be in the phase or in subsequent phases. The DMA compiler 754 may allocate the input and output buffers between the heads in the phase using maximum bandwidth for a given hardware. In this way, the DMA compiler 754 may optimize use of the buffers for the heads in the phase.

At operation 718, the DMA compiler allocates bandwidth of the input and output buffers to a head in the phase and confirms the allocation at operation 719. Operations 718 and 719 may be repeated for each head in the phase. Operations 717-719 may be repeated for each phase of a data movement specified by the user. In this way, the DMA compiler 754 may allocate bandwidth for each head in each phase of the data movement. Alternatively, operations 717-719 may be repeated for each data flow specified by the user for the data movement. In this way, the DMA compiler 754 may allocate bandwidth for each head corresponding to each data flow of the data movement.

At operation 720, the DMA compiler 754 may allocate and/or generate a descriptor for the data flow 755 (i.e., for each base data flow created by decomposing the data flow 755). At operation 721, the DMA compiler 754 may update the descriptor ID of the data flow 755 to match the allocation and confirm the updated descriptor ID at operation 722. Operations 720-722 may be repeated for each registered base data flow.

At operation 723, the DMA compiler 754 may allocate and/or generate a channel for a head base data flow object of the data flow 755. The head base data flow object may be a head of a chain of linked base data flow objects. The generated and/or allocated channel may be a channel of a DMA engine, as discussed herein. At operation 724, the DMA engine may update the descriptor ID of the head base data flow object of the data flow 755 and confirm the updated descriptor ID at operation 725. Operations 723-725 may be repeated for each head base data flow object of the data flow 755 generated by the user. Operations 723-725 may be repeated for each head base data flow object generated by the user of each data flow specified by the user.

At operation 726, the DMA compiler 754 may allocate space for a hardware sequencer program in a buffer, for a head base data flow object generated by decomposing a custom data flow object, if the head base data flow object uses a hardware sequencer. The hardware sequencer may be part of the DMA engine and may perform sequencing for the DMA engine (e.g., padding, address manipulation, etc.). For example, data movement for a full image may be explicitly and fully described in a hardware sequencing mode with a simplified programming model (e.g., an image structure of frame) that handles tile sequencing (triggering), padding, overlapping (offset), order of traversing, and different frame sizes. The hardware sequencer may reduce DMA resource usage (e.g., reduce a number of descriptors, triggers, channels, etc. required), offload control from the VPU for VPU control processing, and reduce the complexity of the DMA programming. This may be accomplished by loading an image or frame descriptor view in the form of a sequence of commands from a local programmable memory. These hardware sequence commands may incorporate each of the operations that result in processes including image padding, tile overlapping or offset, frame offset, image traversal orders, and image size in tile granularity. The hardware sequencer may read the image commands from memory in addition to descriptor information (e.g., from the image commands or from a separate descriptor memory or SRAM) and sequence the tile movements to traverse and paint out the full frame. As discussed herein, the DMA compiler determines whether to use the hardware sequencer to optimize the data flows described by the user. In an example, the DMA compiler determines that the hardware sequencer is not present and uses links specified in the descriptions of the data flows. In this way, a user can be insulated from hardware details, including whether the DMA engine includes a hardware sequencer. The DMA compiler optimizes the data movement based on the available hardware, including the hardware sequencer if the hardware sequencer is included in the available hardware. This allows for users to be insulated from changes and updates to the hardware of the DMA engine. The DMA compiler can, based on APIs from the user or the high-level compiler describing the data flows, optimize the data flows for the data movement.

At operation 727, the DMA compiler 754 may request the data flow 755 to dump the hardware sequencer program to the buffer (i.e., to the allocated space in the buffer). At operation 728, the data flow 755 may dump the hardware sequencer program to the buffer. At operation 729, the DMA compiler 754 may allocate and/or generate a DMA channel referencing the hardware sequencer program. At operation 730, the DMA compiler 754 may update a channel ID of a channel at the data flow 755 to match the allocation of the channel to the hardware sequencer program and confirm the update at operation 731.

Operations 727-731 may be repeated for each head base data flow object which uses the hardware sequencer.

At operation 732, the DMA compiler 754 may, for a head base data flow object generated by decomposing a custom data flow object, generate and/or allocate a DMA channel without allocating space for the hardware sequencer program if the head base data flow object does not use a hardware sequencer. At operation 733, the DMA compiler 754 may update a channel ID of a channel at the data flow 755 to match the allocation of the channel to the base data flow object and confirm the update at operation 734. Operations 732-734 may be repeated for each head base data flow object generated from a custom data flow which does not use a hardware sequencer.

Operations 726-731 (for head base data flow objects using a hardware sequencer) or operations 732-734 (for head base data flow objects not using a hardware sequencer) may be repeated for each head base data flow object generated from a custom data flow in the decompose stage. Operations 726-731 and/or operations 732-734 may be termed a “generate stage,” as DMA channels are generated in these operations.

At operation 735, the DMA compiler 754 may write a trigger value to a VMEM for a base data flow object as a parameter 756 which is set at operation 736 for a PVA 757 to use as a trigger for the base data flow object. The trigger may indicate when the PVA 757 is to trigger execution of the base data flow object by the DMA engine. At operation 737, the DMA compiler 754 may confirm the parameter 756. Operations 735-737 may be repeated for each base data flow object specified by the user. In some implementations, trigger metadata is contained in a handler structure. The handler structure may include a single trigger or multiple triggers in complex, repeating sequences. The handler structure may be generated by the DMA compiler in decomposing the data flows. In this way, the user is insulated from the underlying trigger patterns, as the DMA compiler decomposes the data flows specified by the user, or the high-level compiler, into trigger/buffer patterns. This has the advantage of generating complex triggering and buffering patterns based on the specified data flows, reducing human error which may be introduced in programming complex triggering and buffering patterns.

At operation 738 the DMA compiler 754 may call a post process function for a custom data flow object (i.e., for each base data flow object generated by decomposing the custom data flow object). The DMA compiler 754 may cause metadata of the data flow 755 (a custom data flow) to the VMEM at operation 739 and set the parameter value for the data flow 755 at the PVA 757 at operation 740. The PVA 757 may confirm the parameter 756 at operation 741 and return the parameter 756 to the data flow 755 at operation 742. At operation 743, the DMA compiler confirms the parameter 756 is set. At operation 744, the DMA compiler 754 may return the parameter 756 to the command program 753. Operations 738-745 may be repeated for each custom data flow object specified by the user. At operation 744, the DMA compiler 754 may return all parameters of all base data flow objects specified by the user and of all base data flow objects obtained by decomposing custom data flow objects specified by the user.

At operation 745, the command program 745 may set a hardware sequencer bin at the PVA 757. At operation 746, the PVA 757 may return a status of the hardware sequencer bin (e.g., that the hardware sequencer bin is set as requested). At operation 747, the command program 753 may be updated with the confirmed hardware sequencer bin. Operations 735-747 may be termed a “post-process stage,” as operations 735-747 include operations for processing data flows once they have been decomposed, such as coordinating the base data flow objects with the PVA 757. In this way, the PVA 757 can coordinate the PVU with the DMA for coordinated data processing and movement operations.

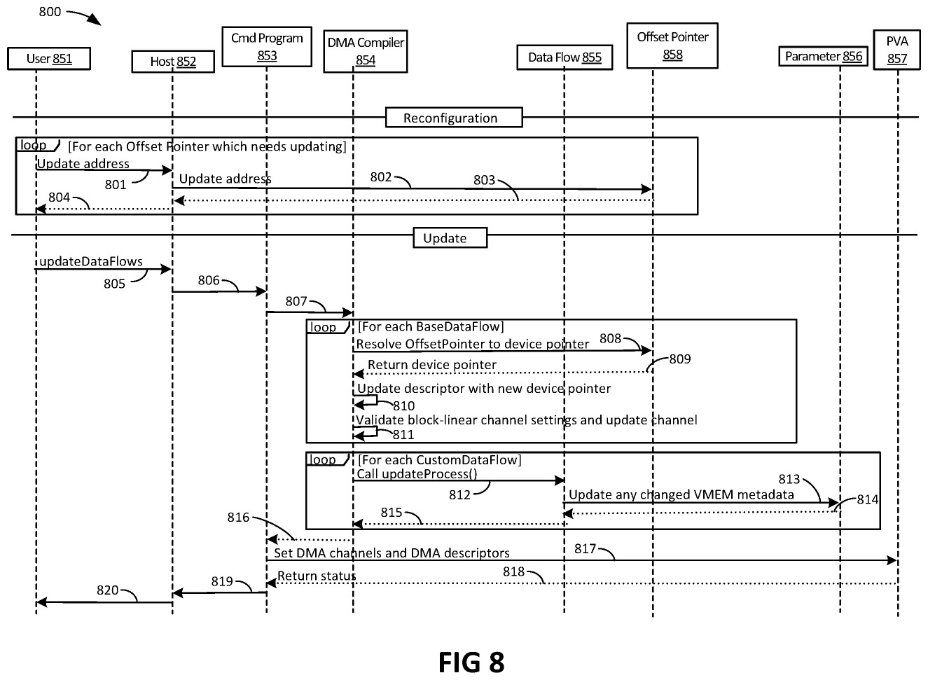

FIG. 8 depicts an example data flow update method 800, in accordance with at least some embodiments of the present disclosure. The method 800 may include more, fewer, or different operations than shown. The operations may be performed in the order shown, in a different order, or concurrently. In complex systems, the exact buffer addresses for a workload may vary between iterations. To support changing buffer addresses between applications of a data movement command program, the base addresses for DMA configurations may be updated without modifying the other sequencing details (advancements, iterations, hardware sequencer bytecode etc.) using Offset Pointers. The user may specify a buffer source/destination address using an Offset Pointer. After compiling dataflows, updates to that Offset Pointer can be made, and the user can apply these updates to the underlying DMA configuration using the method 800. Recompilation of dataflows is not necessary, and the next submission to the DMA device will use the altered buffer addresses. The method 800 is an example method for updating offset pointer addresses.

At operation 801, a user updates an address of an offset pointer 858 at a host device 852. At operation 802, the host device 852 updates the address of the offset pointer 858, confirms the updated address at operation 803, and confirms the update to the user 851 at operation 804. Operations 801-804 may be repeated for each offset point which needs to be updated, or each offset pointer which the user 851 indicates needs to be updated. Operations 801-804 may be termed a “reconfiguration,” as addresses of offset pointers are updated or reconfigured.

At operation 805, the user 851 may instruct the host 852 to update data flows, such as the data flow 858. At operation 806, the host 852 causes the command program 853 to instruct the DMA compiler 854 at operation 807 to update the data flows. At operation 808, the DMA compiler 854 resolves, for a base data flow object of the data flow 855, the offset pointer of the base data flow to a device pointer. At operation 809, the device pointer is returned to the DMA compiler 854. At operation 810, the DMA compiler 854 updates a descriptor of the base data flow object with the new, resolved device pointer. At operation 811, the DMA compiler validates block-linear channel settings of the base data flow object and updates the corresponding channel. Operations 808-811 may be repeated for each base data flow object of the data flow 855. Operations 808-811 may be repeated for each base data flow in a data movement.

At operation 812, the DMA compiler may call an update process for each custom data flow object. In an example, the data flow 855 is a custom data flow object. At operation 813, the data flow 855 is updated with any changed VMEM metadata. At operation 814, a parameter 856 of the data flow 855 which was updated is confirmed to be made to the data flow 855 and returned to the DMA compiler 854 at operation 815. Operations 808-815 may be repeated for each custom data flow object.

At operation 816, the DMA compiler 854 returns the resolved offset pointers and the updated VMEM metadata and/or a status of the resolved offset pointers and updated VMEM metadata to the command program 853. At operation 817, the command program 853 sets DMA channels and DMA descriptors at a PVA 857 in order to inform the PVA 857 of the updated descriptors, updated channel settings, and updated VMEM metadata. At operation 818, the PVA 857 returns a status to the command program 853 which the command program 853 returns to the host 852 at operation 819 and which the host 852 returns to the user 851 at operation 820.

Operations 805-820 may be termed an “update” phase, as the user calls the update function at operation 805 and receives a status of the update at operation 820.

The methods 600, 700, and 800 may provide for a static DMA hardware configuration derived from abstract data flows provided by a user. As discussed herein, the DMA hardware configuration may be generated at runtime, during initialization, before initialization, and/or offline. Runtime device code may provide for signaling when data transfers should begin, wait, and continue as well as dynamically reconfiguring the DMA hardware when a single static configuration cannot meet a use case. In an example, the DMA hardware may be dynamically reconfigured using runtime device code when a buffer address is data-dependent. In this example, the method 800 of FIG. 8 may be used to update the offset pointers of a data flow during runtime.

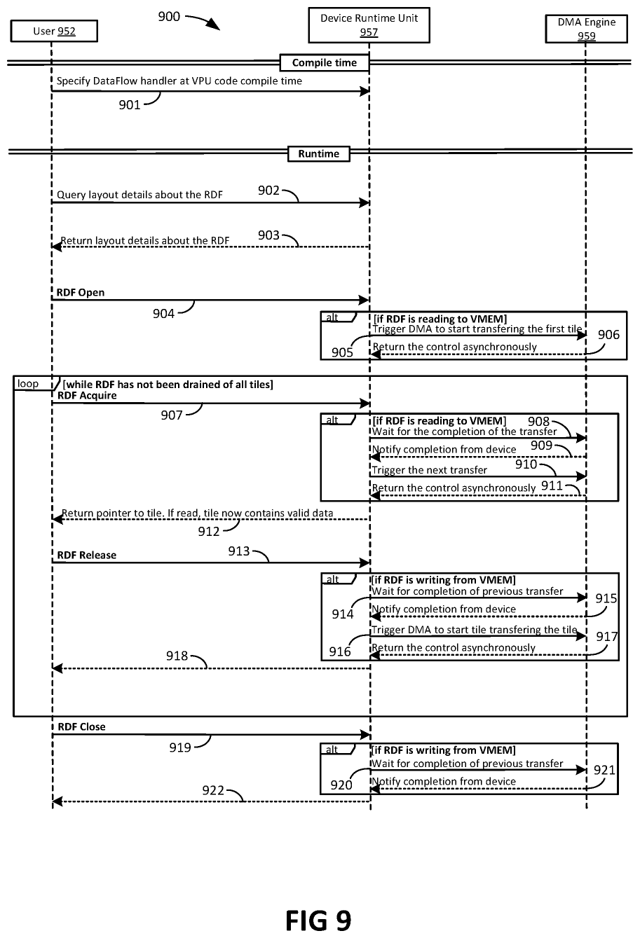

To a user, the device runtime code may be handled at the same level of abstraction as the configuration of data flows. The user may specify data flows and runtime processes which are converted into hardware instructions. FIGS. 9-11 illustrate example methods for generating runtime device code for signaling and/or reconfiguring the DMA hardware based on user input, such as user input received via one or more APIs.

FIG. 9 depicts an example parallel raster data flow implementation method 900, in accordance with at least some embodiments of the present disclosure. The raster data flow implementation method 900 may correspond to the raster data flow shown in FIG. 3. The method 900 may include more, fewer, or different operations than shown. The operations may be performed in the order shown, in a different order, or concurrently. The method 900 may allow a user 952 to make API calls to generate device runtime code for signaling and/or reconfiguring DMA hardware for performing a raster data flow. While the method 900 is described in terms of the user 952 operating a host device making API calls, the method 900 may include the host device automatically making the API calls. In an example, the host device may automatically make API calls to coordinate data movement (e.g., by a DMA engine) and processing (e.g., by a PVU) operations. In an example, a PVA may coordinate the data movement and processing operations without input from the host device.

At operation 901, the user 952, operating a host device, specifies a data flow handler at VPU code compile time to a device runtime unit 957. The user 952 may specify the handler name when configuring data flows, such as in the method 700 of FIG. 7. In some implementations, operation 901 is performed during compile time and operations 902-922 are performed during runtime.

At operation 902, the user 952 may query, at the device runtime unit 957, layout details of a previously created raster data flow (RDF). The user 952 may query the layout details of the RDF using the specified handler of the RDG. At operation 903, the device runtime unit 957 may return the layout details of the RD. At operation 904, the user 952 calls an RDF Open API to open the RDF to allow the RDF to be triggered.

If the RDF is reading to VMEM, the device runtime unit 957 at operation 905 triggers a DMA engine 959 to start transferring a first tile of the RDF and the DMA engine 959 returns the control asynchronously at operation 906.

The DMA engine 959 may buffer tiles to VMEM in different modes, depending upon an amount of VMEM. The different modes may include single buffer, double buffer, and circular buffer. Single buffer mode consumes the least VMEM and has the highest latency, as the next tile can only be brought in after the current tile is released. Double buffer mode consumes twice as much VMEM as the single buffer mode and allows for bringing in the next tile while processing the current tile. Circular buffer mode consumes the most VMEM (e.g., 3-4 times as much as the single buffer mode) and allows for bringing in the next tile while processing the current tile and removes the need to refetch overlapping portions between tiles. The triggering of the DMA engine 959 performed by the device runtime unit 957 is different for each of these different modes. However, the triggering sequence is generated by the DMA compiler in advance, as discussed in conjunction with FIG. 7, based on the APIs provided by the user and/or the higher-level compiler. In this way, the APIs can specify how much VMEM is available and the DMA compiler can select the mode which provides the best performance with the available VMEM. Other modes or methods of buffering tiles may be provided for. The DMA compiler can generate triggering sequences for a variety of hardware based on a consistent set of APIs.

At operation 907, the user 952 calls an RDF Acquire API to the device runtime unit 957 to cause the RDF to access tiles. At operation 912, the device runtime unit returns a pointer to a tile to the user 952 where the tile now contains valid data.

If the RDF is reading to VMEM, the device runtime unit at operation 908 waits for completion of the transfer of the tile, receives notification of the completion from the DMA engine 959 at operation 909, triggers the next transfer at the DMA engine 959 at operation 910, and receives control asynchronously from the DMA engine 959 at operation 911.

VPU processing for reading and writing the tile may occur after operation 912 when the pointer to the tile is returned. The VPU processing may be performed by a VPU of a PVA, as discussed herein.

At operation 913, the user 952 calls an RDF Release API to the device runtime unit 957 to indicate that the RDF no longer needs to access the tile.

If the RDF is reading to VMEM, the device runtime unit at operation 914 waits for completion of the transfer of the tile, receives notification of the completion from the DMA engine 959 at operation 915, triggers the next transfer at the DMA engine 959 at operation 916, and receives control asynchronously from the DMA engine 959 at operation 917.

At operation 918, the device runtime unit 957 confirms release of the tile.

Operations 907-918 may be repeated while the RDF has not been drained of tiles. In some implementations, operations 907-918 are repeated for each tile of the RDF. For single-buffered transfers,

At operation 919, the user 952 may call an RDF Close API to the device runtime unit 957 to close the RDF. At operation 922, the device runtime unit 957 may confirm the RDF is closed, or ended. If the RDF is reading to VMEM, the device runtime unit at operation 920 waits for completion of the transfer of the tile and receives notification of the completion from the DMA engine 959 at operation 921.

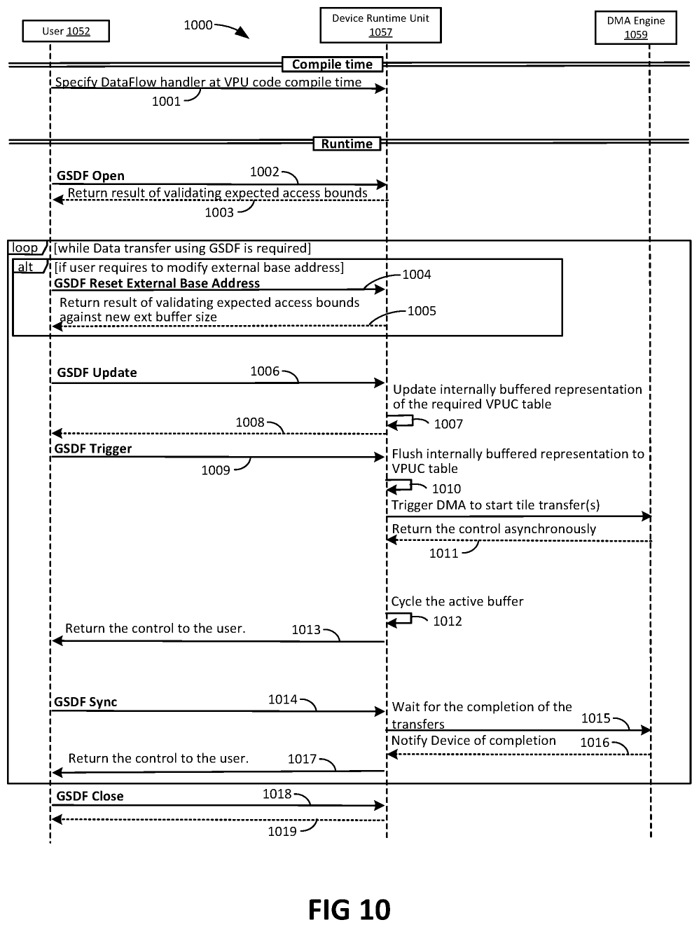

FIG. 10 depicts an example sequential gather/scatter data flow implementation method 1000, in accordance with at least some embodiments of the present disclosure. The raster data flow implementation method 1000 may correspond to the gather/scatter data flow shown in FIG. 4. The method 1000 may include more, fewer, or different operations than shown. The operations may be performed in the order shown, in a different order, or concurrently. The method 1000 may allow a user 1052 to make API calls to generate device runtime code for signaling and/or reconfiguring DMA hardware for performing a gather/scatter data flow. While the method 1000 is described in terms of the user 1052 operating a host device making API calls, the method 1000 may include the host device automatically making the API calls. In an example, the host device may automatically make API calls to coordinate data movement (e.g., by a DMA engine) and processing (e.g., by a PVU) operations. In an example, a PVA may coordinate the data movement and processing operations without input from the host device.

At operation 1001, the user 1052, operating a host device, specifies a data flow handler at VPU code compile time to a device runtime unit 1057. The user 1052 may specify the handler name when configuring data flows, such as in the method 700 of FIG. 7. In some implementations, operation 1001 is performed during compile time and operations 1002-1019 are performed during runtime.

At operation 1002, the user 1052 calls a gather/scatter data flow (GSDF) Open API to the device runtime unit 1057 to open the GSDF. At operation 1003, the device runtime unit 1057 returns a result of validating expected access bounds to the user 1052. In some implementations, the device runtime unit 1057 validates the expected access bounds against a default buffer size.

In some implementations, the user 1052 can initialize ping-pong transfers differently by calling a GSDF Reset External Base Address API, receiving the validation result from the device runtime unit 1057, calling a GSDF Cycle Buffer API, and receiving confirmation from the runtime unit 1057. After this sequence, the current buffer is “pong,” which is configured to point at the default exit buffer. The “ping” buffer is configured to point to whichever buffer was requested by the user 1052. Any GSDF Update API calls can be committed to the default exit buffer or the user-requested buffer.

At operation 1004, the user 1052 calls the GSDF Reset External Base Address API to the device runtime unit 1057 and receives the validation result from the device runtime unit 1057 at operation 1005. Operations 1004 and 1005 may be performed to modify the external base address.

At operation 1006, the user 1052 calls the GSDF Update API to the device runtime unit 1057. At operation 1007, the device runtime unit 1057 updates an internally buffered representation of a VPUC table for the GSDF and returns the result to the user 1052 at operation 1008. At operation 1009, the user 1052 calls the GSDF Trigger API to the device runtime unit 1057. At operation 1010, the device runtime unit 1057 flushes the internally buffered representation to the VPUC table and triggers a DMA engine 1059 to start tile transfers, and receives the control asynchronously from the DMA engine 1059 at operation 1011.

At operation 1012, the device runtime unit 1057 cycles the active buffer and at operation 1013 the device runtime unit 1057 returns the control to the user 1052. VPU processing can happen in parallel with DMA transfers after operation 1013.

At operation 1014, the user 1052 makes a GSDF Sync API call to the device runtime unit 1057. At operation 1015, the device runtime unit 1057 waits for the completion of the tile transfers. At operation 1016, the DMA engine 1059 notifies the device runtime unit 1057 of completion of the tile transfers. At operation 1017, the device runtime unit 1057 returns the control to the user 1052.

Operations 1004-1017 may be repeated while data transfer using GSDF is being performed, or while tiles remain for transfer using GSDF.

At operation 1018, the user 1052 makes a GSDF Close API call to the device runtime unit 1057 to end or close the GSDF. At operation 1019, the device runtime unit 1057 confirms the close of the GSDF to the user 1052.

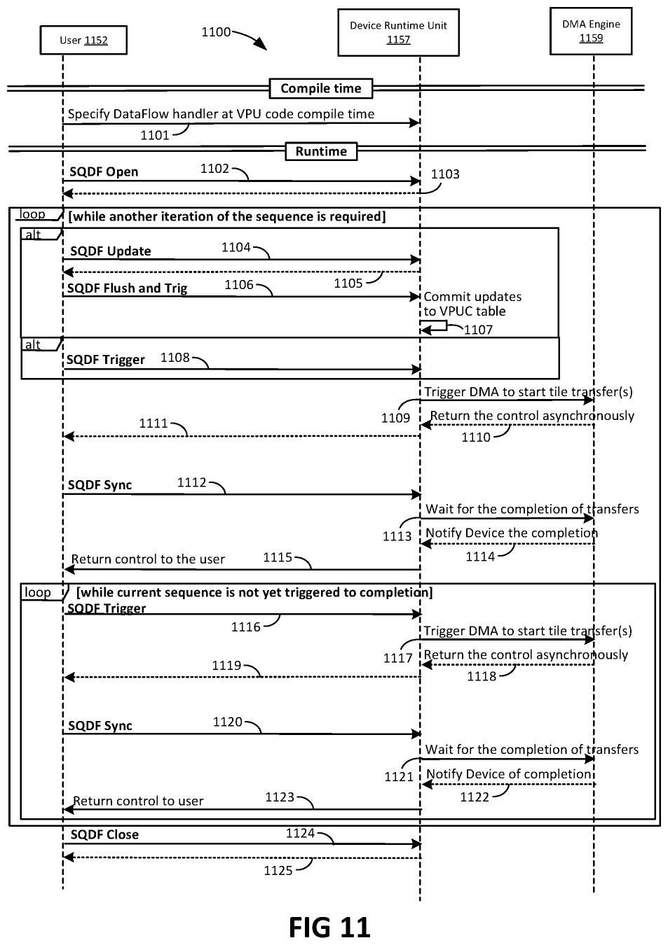

FIG. 11 depicts an example method 1100 for implementation of a data flow for sequential tiled access of 2D images, in accordance with at least some embodiments of the present disclosure. The sequence data flow implementation method 1100 may correspond to the sequence data flow shown in FIG. 5. The method 1100 may include more, fewer, or different operations than shown. The operations may be performed in the order shown, in a different order, or concurrently. The method 1100 may allow a user 1152 to make API calls to generate device runtime code for signaling and/or reconfiguring DMA hardware for performing a sequence data flow. While the method 1100 is described in terms of the user 1152 operating a host device making API calls, the method 1100 may include the host device automatically making the API calls. In an example, the host device may automatically make API calls to coordinate data movement (e.g., by a DMA engine) and processing (e.g., by a PVU) operations. In an example, a PVA may coordinate the data movement and processing operations without input from the host device.

At operation 1101, the user 1152, operating a host device, specifies a data flow handler at VPU code compile time to a device runtime unit 1157. The user 1152 may specify the handler name when configuring data flows, such as in the method 700 of FIG. 7. In some implementations, operation 1101 is performed during compile time and operations 1102-1119 are performed during runtime.

At operation 1102, the user 1152 calls a sequence data flow (SQDF) Open API to the device runtime unit 1157 to open the SQDF. At operation 1103, the device runtime unit 1157 confirms the opening of the SQDF to the user 1152.

At operation 1104, to modify properties of the SQDF, the user 1152 may call the SQDF Update API to the device runtime unit 1157 and receive confirmation from the device runtime unit 1157 at operation 1105. At operation 106, the user 1152 may call an AWDF Flush and Trigger API to the device runtime unit 1157. At operation 1107, the device runtime unit 1157 commits updates to a VPUC table. Operations 1104-1107 may be performed to modify the properties of the SQDF.

If the user does not want to modify the properties of the SQDF, the user 1152 can call an SQDF Trigger API at operation 1108 to the device runtime unit 1157.

At operation 1109, the device runtime unit 1157 triggers a DMA engine 1159 to start tile transfers and receives the control asynchronously from the DMA engine 1159 at operation 1110. At operation 1111, the device runtime unit 1157 returns the result to the user 1152. VPU processing and/or processing for the next sequence iteration can occur after operation 1111.

At operation 1112, the user 1152 makes a SQDF Sync API call to the device runtime unit 1157. At operation 1113, the device runtime unit 1157 waits for completion of the transfers and receives a notification of completion from the DMA engine 1159 at operation 1114. At operation 1115, the device runtime unit 1157 returns control to the user 1152.

At operation 1116, the user 1152 calls an SQDF Trigger API to the device runtime unit 1157. At operation 1117, the device runtime unit 1157 triggers a DMA engine 1159 to start tile transfers and receives the control asynchronously from the DMA engine 1159 at operation 1118. At operation 1119, the device runtime unit 1157 returns the result to the user 1152. VPU processing and/or processing for the next sequence iteration can occur after operation 1119.

At operation 1120, the user 1152 makes a SQDF Sync API call to the device runtime unit 1157. At operation 1121, the device runtime unit 1157 waits for the completion of the transfers and receives a notification of completion from the DMA engine 1159 at operation 1122. At operation 1115, the device runtime unit 1157 returns control to the user 1152.

Operations 1116-1123 may be repeated while the current sequence is not yet triggered to completion. Operations 1104-1123 may be repeated while another iteration of the sequence is required, with operations 1116-1123 repeating within each iteration.

At operation 1124, the user 1152 makes an SQDF Close API call to the device runtime unit 1157 to end or close the SQDF. At operation 1125, the device runtime unit 1157 confirms the close of the SQDF to the user 1152.

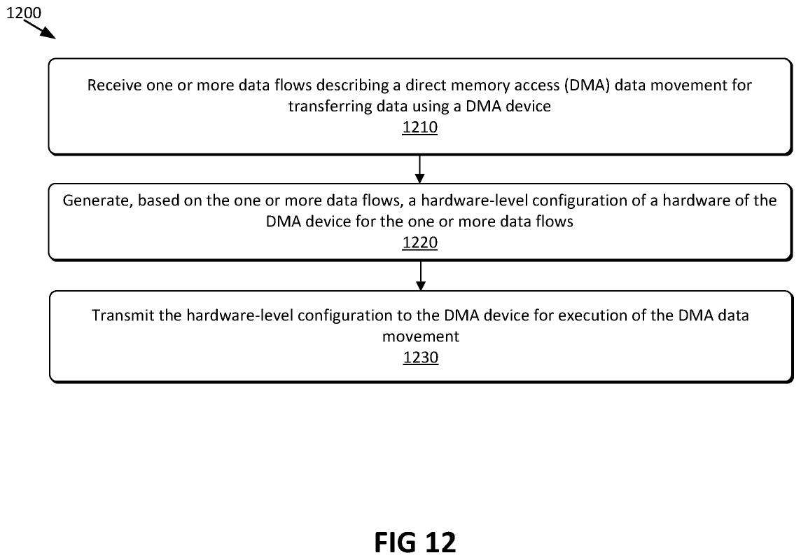

FIG. 12 is a flow chart of an example method 1200 for generating DMA movements based on data flows, in accordance with at least some embodiments of the present disclosure. The method 1200 may include more, fewer, or different operations than shown. The operations may be performed in the order shown, in a different order, or concurrently. In an example, the method 1200 may be performed by one or more components of the system 100 of FIG. 1, such as the control subsystem 111. In an example, the method 1200 may be performed by a DMA compiler, such as the DMA compiler 754 of FIGS. 7A-7C.

At operation 1210, one or more data flows are received describing a direct memory access (DMA) data movement for transferring data using a DMA device. In some implementations, the one or more data flows are high-level abstractions of the data movement. In some implementations, the one or more data flows are received via one or more APIs from a user device. In an example, a user makes a public API call describing the one or more data flows.

In some implementations, the received one or more data flows each include a source and a destination, and wherein the one or more circuits are to determine one or more of phases for the one or more data flows and links for the one or more data flows between the one or more phases. In an example, the received one or more data flows do not include phase descriptions describing in what phases data flows should be executed. In this example, the DMA compiler may optimize bandwidth usage by assigning the data flows to phases and optimizing bandwidth usage within those phases for a global optimization of bandwidth across phases. In an example, the received one or more data flows do not include links describing sequential performance of the data flows and the DMA compiler determines which data flows should be sequentially performed. In an example, the received data flows do not include phase descriptions or links, and the DMA compiler determines links between the data flows and phase assignments for global optimization of bandwidth across the entire data movement.

At operation 1220, a hardware-level configuration of a hardware of the DMA device is generated, based on the one or more data flows, for the one or more data flows. In some implementations, generating the hardware-level configuration includes generating, based on the one or more data flows, an intermediate configuration and generating, based on the intermediate configuration, the hardware-level configuration. In an example, a custom data flow specified by a user is decomposed into base data flows and the base data flows are decomposed into the hardware-level configuration. In an example, the one or more received data flows include a base data flow and a custom data flow and the custom data flow is decomposed into one or more base data flows and then the user-specified base data flow and the generated base data flows are decomposed into the hardware-level configuration.

In some implementations, generating the hardware-level configuration includes allocating hardware resources of the DMA device for the one or more data flows. In some implementations, allocating the hardware resources includes allocating input buffer bandwidth and output buffer bandwidth for the one or more data flows. In an example, allocating the hardware resources includes optimizing allocation of input and output buffers for base data flow objects of the data flow.

In some implementations, generating the hardware-level configuration includes optimizing usage of a bandwidth of the DMA device. In this way, a performance of the DMA device is improved, as the optimization of the bandwidth of the DMA device may improve a throughput of the DMA device. In some implementations, the one or more data flows include a prioritization of the one or more data flows. In an example, optimizing the usage of the bandwidth includes allocating the bandwidth according to weights associated with the one or more data flows, where the weights the prioritization of the one or more data flows. In an example, a first data flow is weighted higher than a second data flow if the first data flow should be completed before the second data flow.

In some implementations, the one or more data flows include phase descriptors for phases of the DMA data movement. The phase descriptors may specify in which phases different data flows of the one or more data flows will occur. In some implementations, optimizing usage of the bandwidth includes optimizing the usage of the bandwidth within each phase of the DMA movement.

In some implementations, the one or more data flows include links corresponding to sequential execution of the one or more data flows. The links may indicate that a set of data flows are to be performed sequentially. The linked data flows may span one or more phases of the data movement. In some implementations, the linked data flows may be allocated an equal portion of bandwidth across all phases in which the linked data flows occur. Optimization of the usage of the bandwidth may take into account the bandwidth usage of the linked data flows across the phases of the linked data flows.

At operation 1230, the hardware-level configuration is transmitted to the DMA device for execution of the DMA data movement. The DMA device may execute the DMA data movement according to the hardware-level configuration in coordination with data processing (e.g., by a VPU). In an example, the DMA device may execute a raster data flow in coordination with data processing by a VPU of tiles transferred in the raster data flow. In some implementations, the DMA device may be reconfigured during runtime.

In some implementations, the method 1200 includes receiving one or more second data flows describing a second DMA data movement for transferring data using a second DMA device, generating, based on the one or more second data flows, a second hardware-level configuration for the one or more second data flows, wherein the second hardware-level configuration corresponds to a hardware of the second DMA device, and transmitting the second hardware-level configuration to the second DMA device for execution of the second DMA data movement. In this way, the generation of the hardware-level configuration can be applied to multiple different devices and hardware specifications. The generation of the hardware-level configurations from received data flows may be hardware-agnostic, allowing for new hardware specifications to be utilized in the method 1200 without requiring changes to the received data flows. In this way, a user may provide data flows for execution with various hardware without having to adapt the data flows. This reduces human error in programming data movements and speeds up generation of configurations for performing data movements.

### Example Data Center

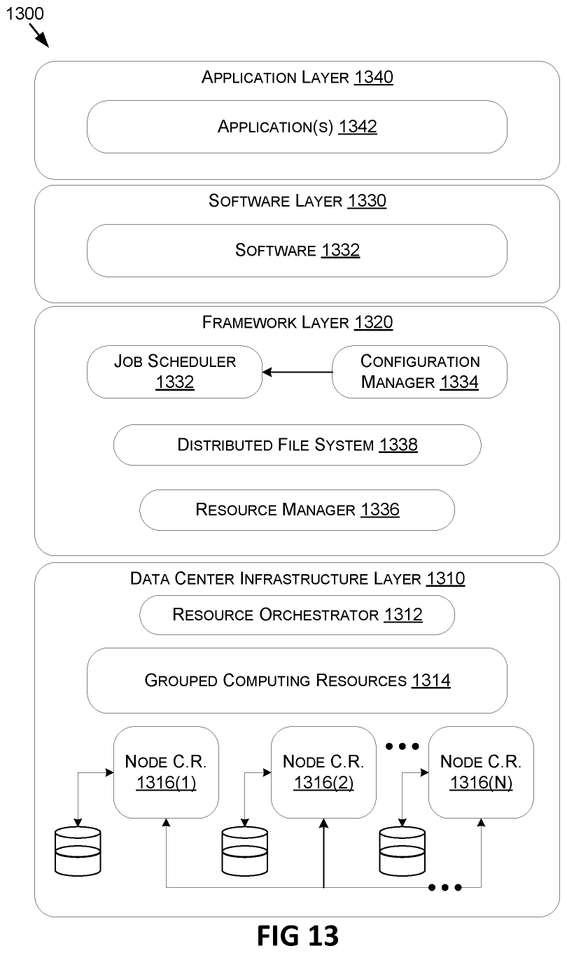

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1332, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1332 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1332. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to perform one or more of the methods and/or processes described herein. In at least one embodiment, the data center 1300 may use CPUs, application-specific integrated circuits (ASICs), GPUs, FPGAs, and/or other hardware (or virtual compute resources corresponding thereto) to perform one or more of the methods and/or processes described herein. Moreover, one or more software and/or hardware resources described above may be configured as a service to allow users to train or performing inferencing of information, such as image recognition, speech recognition, or other artificial intelligence services.

### Example Computing Device

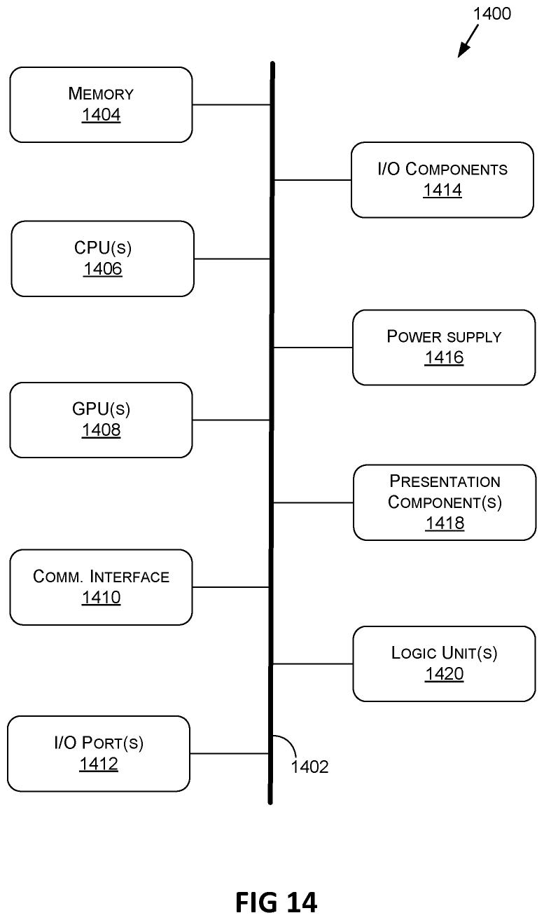

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Autonomous Vehicle

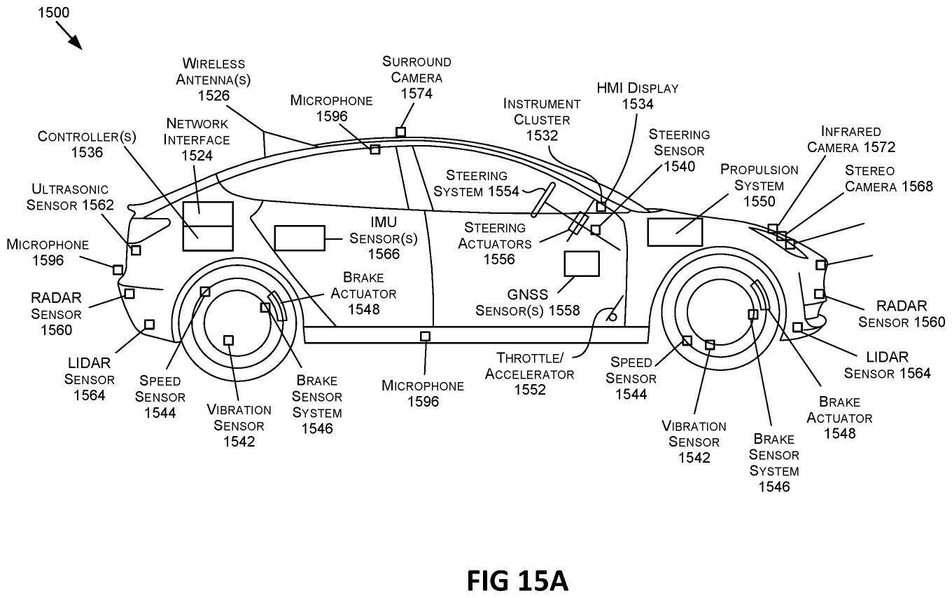

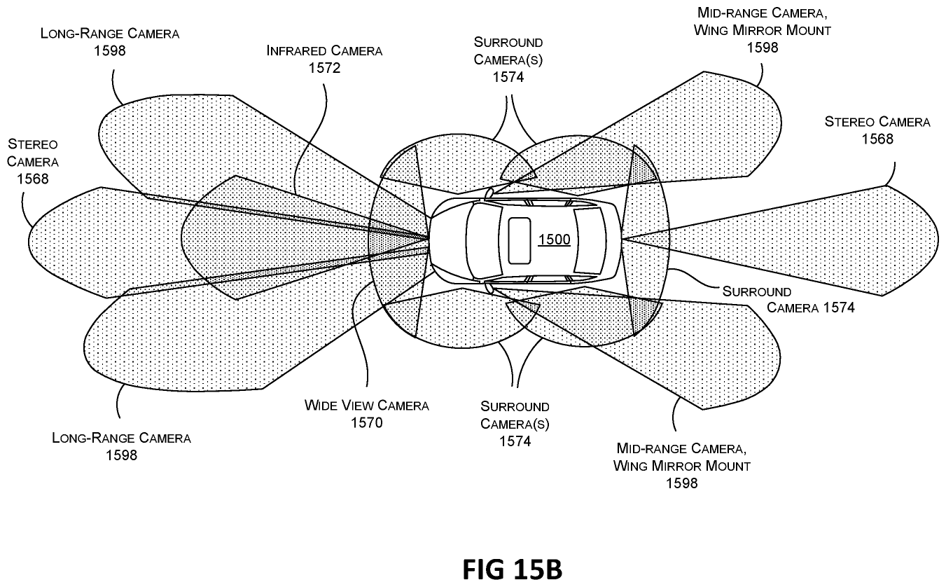

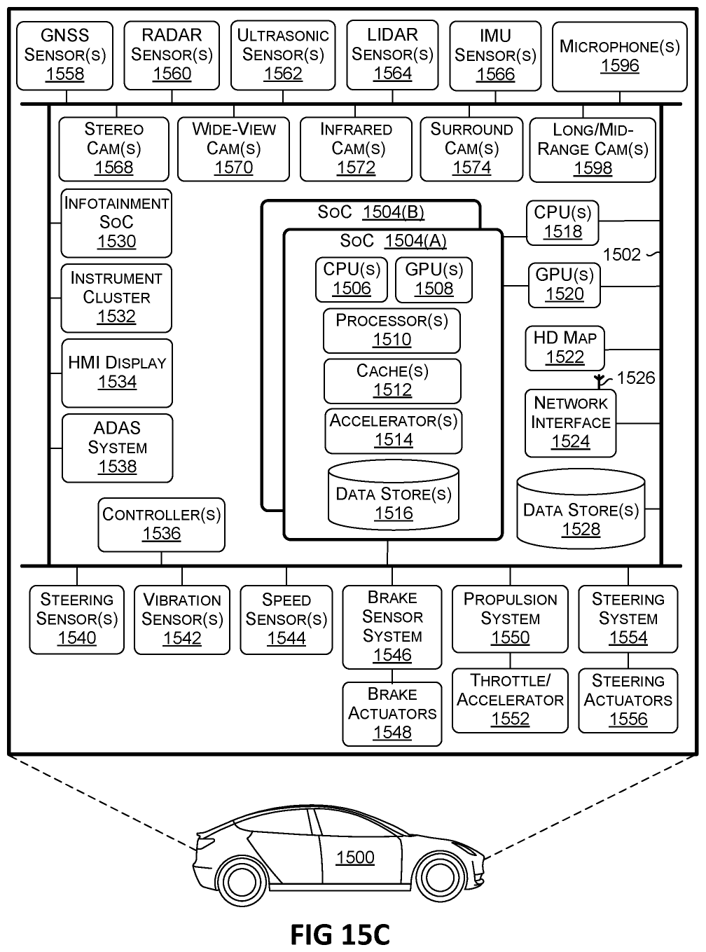

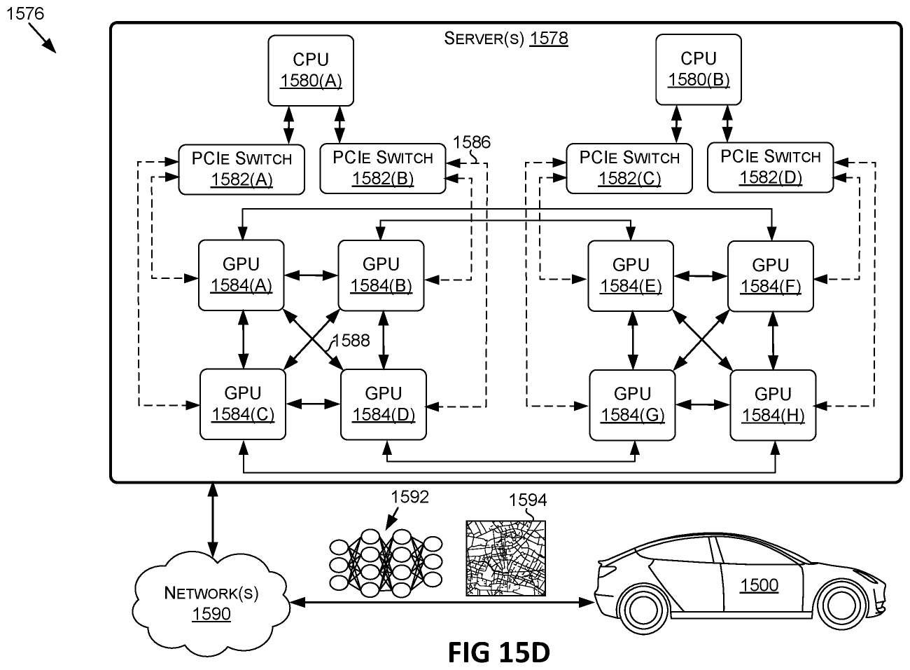

FIG. 15A is an illustration of an example autonomous vehicle 1500, in accordance with some embodiments of the present disclosure. The autonomous vehicle 1500 (alternatively referred to herein as the “vehicle 1500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1500 may be capable of functionality in accordance with one or more of Level 3-Level 5 of the autonomous driving levels. The vehicle 1500 may be capable of functionality in accordance with one or more of Level 1-Level 5 of the autonomous driving levels. For example, the vehicle 1500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1500 or other machine, such as being fully autonomous, being highly autonomous, being conditionally autonomous, being partially autonomous, providing assistive autonomy, being semi-autonomous, being primarily autonomous, or other designation.

The vehicle 1500 may include components such as a chassis, a vehicle body, wheels (e.g., 2, 4, 6, 8, 18, etc.), tires, axles, and other components of a vehicle. The vehicle 1500 may include a propulsion system 1550, such as an internal combustion engine, hybrid electric power plant, an all-electric engine, and/or another propulsion system type. The propulsion system 1550 may be connected to a drive train of the vehicle 1500, which may include a transmission, to enable the propulsion of the vehicle 1500. The propulsion system 1550 may be controlled in response to receiving signals from the throttle/accelerator 1552.

A steering system 1554, which may include a steering wheel, may be used to steer the vehicle 1500 (e.g., along a desired path or route) when the propulsion system 1550 is operating (e.g., when the vehicle is in motion). The steering system 1554 may receive signals from a steering actuator 1556. The steering wheel may be optional for full automation (Level 5) functionality.

The brake sensor system 1546 may be used to operate the vehicle brakes in response to receiving signals from the brake actuators 1548 and/or brake sensors.

Controller(s) 1536, which may include one or more system on chips (SoCs) 1504 (FIG. 15C) and/or GPU(s), may provide signals (e.g., representative of commands) to one or more components and/or systems of the vehicle 1500. For example, the controller(s) may send signals to operate the vehicle brakes via one or more brake actuators 1548, to operate the steering system 1554 via one or more steering actuators 1556, to operate the propulsion system 1550 via one or more throttle/accelerators 1552. The controller(s) 1536 may include one or more onboard (e.g., integrated) computing devices (e.g., supercomputers) that process sensor signals, and output operation commands (e.g., signals representing commands) to enable autonomous driving and/or to assist a human driver in driving the vehicle 1500. The controller(s) 1536 may include a first controller 1536 for autonomous driving functions, a second controller 1536 for functional safety functions, a third controller 1536 for artificial intelligence functionality (e.g., computer vision), a fourth controller 1536 for infotainment functionality, a fifth controller 1536 for redundancy in emergency conditions, and/or other controllers. In some examples, a single controller 1536 may handle two or more of the above functionalities, two or more controllers 1536 may handle a single functionality, and/or any combination thereof.

The controller(s) 1536 may provide the signals for controlling one or more components and/or systems of the vehicle 1500 in response to sensor data received from one or more sensors (e.g., sensor inputs). The sensor data may be received from, for example and without limitation, global navigation satellite systems (“GNSS”) sensor(s) 1558 (e.g., Global Positioning System sensor(s)), RADAR sensor(s) 1560, ultrasonic sensor(s) 1562, LiDAR sensor(s) 1564, inertial measurement unit (IMU) sensor(s) 1566 (e.g., accelerometer(s), gyroscope(s), magnetic compass(es), magnetometer(s), etc.), microphone(s) 1596, stereo camera(s) 1568, wide-view camera(s) 1570 (e.g., fisheye cameras), infrared camera(s) 1572, surround camera(s) 1574 (e.g., 360 degree cameras), long-range and/or mid-range camera(s) 1598, speed sensor(s) 1544 (e.g., for measuring the speed of the vehicle 1500), vibration sensor(s) 1542, steering sensor(s) 1540, brake sensor(s) (e.g., as part of the brake sensor system 1546), and/or other sensor types.

One or more of the controller(s) 1536 may receive inputs (e.g., represented by input data) from an instrument cluster 1532 of the vehicle 1500 and provide outputs (e.g., represented by output data, display data, etc.) via a human-machine interface (HMI) display 1534, an audible annunciator, a loudspeaker, and/or via other components of the vehicle 1500. The outputs may include information such as vehicle velocity, speed, time, map data (e.g., the High Definition (“HD”) map 1522 of FIG. 15C), location data (e.g., the vehicle's 1500 location, such as on a map), direction, location of other vehicles (e.g., an occupancy grid), information about objects and status of objects as perceived by the controller(s) 1536, etc. For example, the HMI display 1534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1500 further includes a network interface 1524 which may use one or more wireless antenna(s) 1526 and/or modem(s) to communicate over one or more networks. For example, the network interface 1524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 15B is an example of camera locations and fields of view for the example autonomous vehicle 1500 of FIG. 15A, in accordance with some embodiments of the present disclosure. The cameras and respective fields of view are one example embodiment and are not intended to be limiting. For example, additional and/or alternative cameras may be included and/or the cameras may be located at different locations on the vehicle 1500.

The camera types for the cameras may include, but are not limited to, digital cameras that may be adapted for use with the components and/or systems of the vehicle 1500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1500 (e.g., front-facing cameras) may be used for surround view, to help identify forward facing paths and obstacles, as well aid in, with the help of one or more controllers 1536 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1570 that may be used to perceive objects coming into view from the periphery (e.g., pedestrians, crossing traffic or bicycles). Although only one wide-view camera is illustrated in FIG. 15B, there may be any number (including zero) of wide-view cameras 1570 on the vehicle 1500. In addition, any number of long-range camera(s) 1598 (e.g., a long-view stereo camera pair) may be used for depth-based object detection, especially for objects for which a neural network has not yet been trained. The long-range camera(s) 1598 may also be used for object detection and classification, as well as basic object tracking.

Any number of stereo cameras 1568 may also be included in a front-facing configuration. In at least one embodiment, one or more of stereo camera(s) 1568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1568 may be used in addition to, or alternatively from, those described herein.

Cameras with a field of view that include portions of the environment to the side of the vehicle 1500 (e.g., side-view cameras) may be used for surround view, providing information used to create and update the occupancy grid, as well as to generate side impact collision warnings. For example, surround camera(s) 1574 (e.g., four surround cameras 1574 as illustrated in FIG. 15B) may be positioned to on the vehicle 1500. The surround camera(s) 1574 may include wide-view camera(s) 1570, fisheye camera(s), 360 degree camera(s), and/or the like. Four example, four fisheye cameras may be positioned on the vehicle's front, rear, and sides. In an alternative arrangement, the vehicle may use three surround camera(s) 1574 (e.g., left, right, and rear), and may leverage one or more other camera(s) (e.g., a forward-facing camera) as a fourth surround view camera.

Cameras with a field of view that include portions of the environment to the rear of the vehicle 1500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1598, stereo camera(s) 1568), infrared camera(s) 1572, etc.), as described herein.

FIG. 15C is a block diagram of an example system architecture for the example autonomous vehicle 1500 of FIG. 15A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1500 in FIG. 15C are illustrated as being connected via bus 1502. The bus 1502 may include a Controller Area Network (CAN) data interface (alternatively referred to herein as a “CAN bus”). A CAN may be a network inside the vehicle 1500 used to aid in control of various features and functionality of the vehicle 1500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1502 is described herein as being a CAN bus, this is not intended to be limiting. For example, in addition to, or alternatively from, the CAN bus, FlexRay and/or Ethernet may be used. Additionally, although a single line is used to represent the bus 1502, this is not intended to be limiting. For example, there may be any number of busses 1502, which may include one or more CAN busses, one or more FlexRay busses, one or more Ethernet busses, and/or one or more other types of busses using a different protocol. In some examples, two or more busses 1502 may be used to perform different functions, and/or may be used for redundancy. For example, a first bus 1502 may be used for collision avoidance functionality and a second bus 1502 may be used for actuation control. In any example, each bus 1502 may communicate with any of the components of the vehicle 1500, and two or more busses 1502 may communicate with the same components. In some examples, each SoC 1504, each controller 1536, and/or each computer within the vehicle may have access to the same input data (e.g., inputs from sensors of the vehicle 1500), and may be connected to a common bus, such the CAN bus.

The vehicle 1500 may include one or more controller(s) 1536, such as those described herein with respect to FIG. 15A. The controller(s) 1536 may be used for a variety of functions. The controller(s) 1536 may be coupled to any of the various other components and systems of the vehicle 1500, and may be used for control of the vehicle 1500, artificial intelligence of the vehicle 1500, infotainment for the vehicle 1500, and/or the like.

The vehicle 1500 may include a system(s) on a chip (SoC) 1504. The SoC 1504 may include CPU(s) 1506, GPU(s) 1508, processor(s) 1510, cache(s) 1512, accelerator(s) 1514, data store(s) 1516, and/or other components and features not illustrated. The SoC(s) 1504 may be used to control the vehicle 1500 in a variety of platforms and systems. For example, the SoC(s) 1504 may be combined in a system (e.g., the system of the vehicle 1500) with an HD map 1522 which may obtain map refreshes and/or updates via a network interface 1524 from one or more servers (e.g., server(s) 1578 of FIG. 15D).

The CPU(s) 1506 may include a CPU cluster or CPU complex (alternatively referred to herein as a “CCPLEX”). The CPU(s) 1506 may include multiple cores and/or L2 caches. For example, in some embodiments, the CPU(s) 1506 may include eight cores in a coherent multi-processor configuration. In some embodiments, the CPU(s) 1506 may include four dual-core clusters where each cluster has a dedicated L2 cache (e.g., a 2 MB L2 cache). The CPU(s) 1506 (e.g., the CCPLEX) may be configured to support simultaneous cluster operation enabling any combination of the clusters of the CPU(s) 1506 to be active at any given time.

The CPU(s) 1506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1508 may include an integrated GPU (alternatively referred to herein as an “iGPU”). The GPU(s) 1508 may be programmable and may be efficient for parallel workloads. The GPU(s) 1508, in some examples, may use an enhanced tensor instruction set. The GPU(s) 1508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1508 may include at least eight streaming microprocessors. The GPU(s) 1508 may use compute application programming interface(s) (API(s)). In addition, the GPU(s) 1508 may use one or more parallel computing platforms and/or programming models (e.g., NVIDIA's CUDA).

The GPU(s) 1508 may be power-optimized for best performance in automotive and embedded use cases. For example, the GPU(s) 1508 may be fabricated on a Fin field-effect transistor (FinFET). However, this is not intended to be limiting and the GPU(s) 1508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1508 to access the CPU(s) 1506 page tables directly. In such examples, when the GPU(s) 1508 memory management unit (MMU) experiences a miss, an address translation request may be transmitted to the CPU(s) 1506. In response, the CPU(s) 1506 may look in its page tables for the virtual-to-physical mapping for the address and transmits the translation back to the GPU(s) 1508. As such, unified memory technology may allow a single unified virtual address space for memory of both the CPU(s) 1506 and the GPU(s) 1508, thereby simplifying the GPU(s) 1508 programming and porting of applications to the GPU(s) 1508.

In addition, the GPU(s) 1508 may include an access counter that may keep track of the frequency of access of the GPU(s) 1508 to memory of other processors. The access counter may help ensure that memory pages are moved to the physical memory of the processor that is accessing the pages most frequently.

The SoC(s) 1504 may include any number of cache(s) 1512, including those described herein. For example, the cache(s) 1512 may include an L3 cache that is available to both the CPU(s) 1506 and the GPU(s) 1508 (e.g., that is connected both the CPU(s) 1506 and the GPU(s) 1508). The cache(s) 1512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1504 may include an arithmetic logic unit(s) (ALU(s)) which may be leveraged in performing processing with respect to any of the variety of tasks or operations of the vehicle 1500—such as processing DNNs. In addition, the SoC(s) 1504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1506 and/or GPU(s) 1508.

The SoC(s) 1504 may include one or more accelerators 1514 (e.g., hardware accelerators, software accelerators, or a combination thereof). For example, the SoC(s) 1504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1508 and to off-load some of the tasks of the GPU(s) 1508 (e.g., to free up more cycles of the GPU(s) 1508 for performing other tasks). As an example, the accelerator(s) 1514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1508, and by using an inference accelerator, for example, a designer may target either the DLA(s) or the GPU(s) 1508 for any function. For example, the designer may focus processing of CNNs and floating point operations on the DLA(s) and leave other functions to the GPU(s) 1508 and/or other accelerator(s) 1514.

The accelerator(s) 1514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

In an example, the SoC 1504 includes one or more DMA systems, as discussed herein, and one or more processors to generate hardware-level configurations for the one or more DMA systems based on high-level descriptions of data flows, as discussed herein. In this example, the one or more processors may receive one or more data flows describing a direct memory access (DMA) data movement for transferring data using the one or more DMA systems, generate, based at least on the one or more data flows, a hardware-level configuration of a hardware of the one or more DMA systems for the one or more data flows, and, transmit the hardware-level configuration to the one or more DMA systems.

The accelerator(s) 1514 (e.g., the hardware acceleration cluster) may include a computer vision network on-chip and SRAM, for providing a high-bandwidth, low latency SRAM for the accelerator(s) 1514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1566 output that correlates with the vehicle 1500 orientation, distance, 3D location estimates of the object obtained from the neural network and/or other sensors (e.g., LiDAR sensor(s) 1564 or RADAR sensor(s) 1560), among others.

The SoC(s) 1504 may include data store(s) 1516 (e.g., memory). The data store(s) 1516 may be on-chip memory of the SoC(s) 1504, which may store neural networks to be executed on the GPU and/or the DLA. In some examples, the data store(s) 1516 may be large enough in capacity to store multiple instances of neural networks for redundancy and safety. The data store(s) 1512 may comprise L2 or L3 cache(s) 1512. Reference to the data store(s) 1516 may include reference to the memory associated with the PVA, DLA, and/or other accelerator(s) 1514, as described herein.

The SoC(s) 1504 may include one or more processor(s) 1510 (e.g., embedded processors). The processor(s) 1510 may include a boot and power management processor that may be a dedicated processor and subsystem to handle boot power and management functions and related security enforcement. The boot and power management processor may be a part of the SoC(s) 1504 boot sequence and may provide runtime power management services. The boot power and management processor may provide clock and voltage programming, assistance in system low power state transitions, management of SoC(s) 1504 thermals and temperature sensors, and/or management of the SoC(s) 1504 power states. Each temperature sensor may be implemented as a ring-oscillator whose output frequency is proportional to temperature, and the SoC(s) 1504 may use the ring-oscillators to detect temperatures of the CPU(s) 1506, GPU(s) 1508, and/or accelerator(s) 1514. If temperatures are determined to exceed a threshold, the boot and power management processor may enter a temperature fault routine and put the SoC(s) 1504 into a lower power state and/or put the vehicle 1500 into a chauffeur to safe stop mode (e.g., bring the vehicle 1500 to a safe stop).

The processor(s) 1510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1510 may further include a real-time camera engine that may include a dedicated processor subsystem for handling real-time camera management.

The processor(s) 1510 may further include a high-dynamic range signal processor that may include an image signal processor that is a hardware engine that is part of the camera processing pipeline.

The processor(s) 1510 may include a video image compositor that may be a processing block (e.g., implemented on a microprocessor) that implements video post-processing functions needed by a video playback application to produce the final image for the player window. The video image compositor may perform lens distortion correction on wide-view camera(s) 1570, surround camera(s) 1574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1508 is not required to continuously render new surfaces. Even when the GPU(s) 1508 is powered on and active doing 3D rendering, the video image compositor may be used to offload the GPU(s) 1508 to improve performance and responsiveness.

The SoC(s) 1504 may further include a mobile industry processor interface (MIPI) camera serial interface for receiving video and input from cameras, a high-speed interface, and/or a video input block that may be used for camera and related pixel input functions. The SoC(s) 1504 may further include an input/output controller(s) that may be controlled by software and may be used for receiving I/O signals that are uncommitted to a specific role.

The SoC(s) 1504 may further include a broad range of peripheral interfaces to enable communication with peripherals, audio codecs, power management, and/or other devices. The SoC(s) 1504 may be used to process data from cameras (e.g., connected over Gigabit Multimedia Serial Link and Ethernet), sensors (e.g., LiDAR sensor(s) 1564, RADAR sensor(s) 1560, etc. that may be connected over Ethernet), data from bus 1502 (e.g., speed of vehicle 1500, steering wheel position, etc.), data from GNSS sensor(s) 1558 (e.g., connected over Ethernet or CAN bus). The SoC(s) 1504 may further include dedicated high-performance mass storage controllers that may include their own DMA engines, and that may be used to free the CPU(s) 1506 from routine data management tasks.

The SoC(s) 1504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1504 may be faster, more reliable, and even more energy-efficient and space-efficient than conventional systems. For example, the accelerator(s) 1514, when combined with the CPU(s) 1506, the GPU(s) 1508, and the data store(s) 1516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1508.

In some examples, a CNN for facial recognition and vehicle owner identification may use data from camera sensors to identify the presence of an authorized driver and/or owner of the vehicle 1500. The always on sensor processing engine may be used to unlock the vehicle when the owner approaches the driver door and turn on the lights, and, in security mode, to disable the vehicle when the owner leaves the vehicle. In this way, the SoC(s) 1504 provide for security against theft and/or carjacking.

In another example, a CNN for emergency vehicle detection and identification may use data from microphones 1596 to detect and identify emergency vehicle sirens. In contrast to conventional systems, that use general classifiers to detect sirens and manually extract features, the SoC(s) 1504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1562, until the emergency vehicle(s) passes.

The vehicle may include a CPU(s) 1518 (e.g., discrete CPU(s), or dCPU(s)), that may be coupled to the SoC(s) 1504 via a high-speed interconnect (e.g., PCIe). The CPU(s) 1518 may include an X86 processor, for example. The CPU(s) 1518 may be used to perform any of a variety of functions, including arbitrating potentially inconsistent results between ADAS sensors and the SoC(s) 1504, and/or monitoring the status and health of the controller(s) 1536 and/or infotainment SoC 1530, for example.

The vehicle 1500 may include a GPU(s) 1520 (e.g., discrete GPU(s), or dGPU(s)), that may be coupled to the SoC(s) 1504 via a high-speed interconnect (e.g., NVIDIA's NVLINK). The GPU(s) 1520 may provide additional artificial intelligence functionality, such as by executing redundant and/or different neural networks, and may be used to train and/or update neural networks based on input (e.g., sensor data) from sensors of the vehicle 1500.

The vehicle 1500 may further include the network interface 1524 which may include one or more wireless antennas 1526 (e.g., one or more wireless antennas for different communication protocols, such as a cellular antenna, a Bluetooth antenna, etc.). The network interface 1524 may be used to enable wireless connectivity over the Internet with the cloud (e.g., with the server(s) 1578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1500 information about vehicles in proximity to the vehicle 1500 (e.g., vehicles in front of, on the side of, and/or behind the vehicle 1500). This functionality may be part of a cooperative adaptive cruise control functionality of the vehicle 1500.

The network interface 1524 may include a SoC that provides modulation and demodulation functionality and enables the controller(s) 1536 to communicate over wireless networks. The network interface 1524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1500 may further include data store(s) 1528 which may include off-chip (e.g., off the SoC(s) 1504) storage. The data store(s) 1528 may include one or more storage elements including RAM, SRAM, DRAM, VRAM, Flash, hard disks, and/or other components and/or devices that may store at least one bit of data.

The vehicle 1500 may further include GNSS sensor(s) 1558. The GNSS sensor(s) 1558 (e.g., GPS, assisted GPS sensors, differential GPS (DGPS) sensors, etc.), to assist in mapping, perception, occupancy grid generation, and/or path planning functions. Any number of GNSS sensor(s) 1558 may be used, including, for example and without limitation, a GPS using a USB connector with an Ethernet to Serial (RS-232) bridge.

The vehicle 1500 may further include RADAR sensor(s) 1560. The RADAR sensor(s) 1560 may be used by the vehicle 1500 for long-range vehicle detection, even in darkness and/or severe weather conditions. RADAR functional safety levels may be ASIL B. The RADAR sensor(s) 1560 may use the CAN and/or the bus 1502 (e.g., to transmit data generated by the RADAR sensor(s) 1560) for control and to access object tracking data, with access to Ethernet to access raw data in some examples. A wide variety of RADAR sensor types may be used. For example, and without limitation, the RADAR sensor(s) 1560 may be suitable for front, rear, and side RADAR use. In some example, Pulse Doppler RADAR sensor(s) are used.

The RADAR sensor(s) 1560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1500 surroundings at higher speeds with minimal interference from traffic in adjacent lanes. The other two antennae may expand the field of view, making it possible to quickly detect vehicles entering or leaving the vehicle's 1500 lane.

Mid-range RADAR systems may include, as an example, a range of up to 1560 m (front) or 80 m (rear), and a field of view of up to 42 degrees (front) or 1550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1500 may further include ultrasonic sensor(s) 1562. The ultrasonic sensor(s) 1562, which may be positioned at the front, back, and/or the sides of the vehicle 1500, may be used for park assist and/or to create and update an occupancy grid. A wide variety of ultrasonic sensor(s) 1562 may be used, and different ultrasonic sensor(s) 1562 may be used for different ranges of detection (e.g., 2.5 m, 4 m). The ultrasonic sensor(s) 1562 may operate at functional safety levels of ASIL B.

The vehicle 1500 may include LiDAR sensor(s) 1564. The LiDAR sensor(s) 1564 may be used for object and pedestrian detection, emergency braking, collision avoidance, and/or other functions. The LiDAR sensor(s) 1564 may be functional safety level ASIL B. In some examples, the vehicle 1500 may include multiple LiDAR sensors 1564 (e.g., two, four, six, etc.) that may use Ethernet (e.g., to provide data to a Gigabit Ethernet switch).

In some examples, the LiDAR sensor(s) 1564 may be capable of providing a list of objects and their distances for a 360-degree field of view. Commercially available LiDAR sensor(s) 1564 may have an advertised range of approximately 1500 m, with an accuracy of 2 cm-3 cm, and with support for a 1500 Mbps Ethernet connection, for example. In some examples, one or more non-protruding LiDAR sensors 1564 may be used. In such examples, the LiDAR sensor(s) 1564 may be implemented as a small device that may be embedded into the front, rear, sides, and/or corners of the vehicle 1500. The LiDAR sensor(s) 1564, in such examples, may provide up to a 120-degree horizontal and 35-degree vertical field-of-view, with a 200 m range even for low-reflectivity objects. Front-mounted LiDAR sensor(s) 1564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1564 may be less susceptible to motion blur, vibration, and/or shock.

The vehicle may further include IMU sensor(s) 1566. The IMU sensor(s) 1566 may be located at a center of the rear axle of the vehicle 1500, in some examples. The IMU sensor(s) 1566 may include, for example and without limitation, an accelerometer(s), a magnetometer(s), a gyroscope(s), a magnetic compass(es), and/or other sensor types. In some examples, such as in six-axis applications, the IMU sensor(s) 1566 may include accelerometers and gyroscopes, while in nine-axis applications, the IMU sensor(s) 1566 may include accelerometers, gyroscopes, and magnetometers.

In some embodiments, the IMU sensor(s) 1566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1566 may enable the vehicle 1500 to estimate heading without requiring input from a magnetic sensor by directly observing and correlating the changes in velocity from GPS to the IMU sensor(s) 1566. In some examples, the IMU sensor(s) 1566 and the GNSS sensor(s) 1558 may be combined in a single integrated unit.

The vehicle may include microphone(s) 1596 placed in and/or around the vehicle 1500. The microphone(s) 1596 may be used for emergency vehicle detection and identification, among other things.

The vehicle may further include any number of camera types, including stereo camera(s) 1568, wide-view camera(s) 1570, infrared camera(s) 1572, surround camera(s) 1574, long-range and/or mid-range camera(s) 1598, and/or other camera types. The cameras may be used to capture image data around an entire periphery of the vehicle 1500. The types of cameras used depends on the embodiments and requirements for the vehicle 1500, and any combination of camera types may be used to provide the necessary coverage around the vehicle 1500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 15A and FIG. 15B.

The vehicle 1500 may further include vibration sensor(s) 1542. The vibration sensor(s) 1542 may measure vibrations of components of the vehicle, such as the axle(s). For example, changes in vibrations may indicate a change in road surfaces. In another example, when two or more vibration sensors 1542 are used, the differences between the vibrations may be used to determine friction or slippage of the road surface (e.g., when the difference in vibration is between a power-driven axle and a freely rotating axle).

The vehicle 1500 may include an ADAS system 1538. The ADAS system 1538 may include a SoC, in some examples. The ADAS system 1538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1560, LiDAR sensor(s) 1564, and/or a camera(s). The ACC systems may include longitudinal ACC and/or lateral ACC. Longitudinal ACC monitors and controls the distance to the vehicle immediately ahead of the vehicle 1500 and automatically adjust the vehicle speed to maintain a safe distance from vehicles ahead. Lateral ACC performs distance keeping, and advises the vehicle 1500 to change lanes when necessary. Lateral ACC is related to other ADAS applications such as LCA and CWS.

CACC uses information from other vehicles that may be received via the network interface 1524 and/or the wireless antenna(s) 1526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1500), while the I2V communication concept provides information about traffic further ahead. CACC systems may include either or both I2V and V2V information sources. Given the information of the vehicles ahead of the vehicle 1500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1500 if the vehicle 1500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1500 is backing up. Some RCTW systems include AEB to ensure that the vehicle brakes are applied to avoid a crash. RCTW systems may use one or more rear-facing RADAR sensor(s) 1560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1500, the vehicle 1500 itself must, in the case of conflicting results, decide whether to heed the result from a primary computer or a secondary computer (e.g., a first controller 1536 or a second controller 1536). For example, in some embodiments, the ADAS system 1538 may be a backup and/or secondary computer for providing perception information to a backup computer rationality module. The backup computer rationality monitor may run a redundant diverse software on hardware components to detect faults in perception and dynamic driving tasks. Outputs from the ADAS system 1538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1504.

In other examples, ADAS system 1538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1538 may be fed into the primary computer's perception block and/or the primary computer's dynamic driving task block. For example, if the ADAS system 1538 indicates a forward crash warning due to an object immediately ahead, the perception block may use this information when identifying objects. In other examples, the secondary computer may have its own neural network which is trained and thus reduces the risk of false positives, as described herein.

The vehicle 1500 may further include the infotainment SoC 1530 (e.g., an in-vehicle infotainment system (IVI)). Although illustrated and described as a SoC, the infotainment system may not be a SoC, and may include two or more discrete components. The infotainment SoC 1530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1500. For example, the infotainment SoC 1530 may radios, disk players, navigation systems, video players, USB and Bluetooth connectivity, carputers, in-car entertainment, Wi-Fi, steering wheel audio controls, hands free voice control, a heads-up display (HUD), an HMI display 1534, a telematics device, a control panel (e.g., for controlling and/or interacting with various components, features, and/or systems), and/or other components. The infotainment SoC 1530 may further be used to provide information (e.g., visual and/or audible) to a user(s) of the vehicle, such as information from the ADAS system 1538, autonomous driving information such as planned vehicle maneuvers, trajectories, surrounding environment information (e.g., intersection information, vehicle information, road information, etc.), and/or other information.

The infotainment SoC 1530 may include GPU functionality. The infotainment SoC 1530 may communicate over the bus 1502 (e.g., CAN bus, Ethernet, etc.) with other devices, systems, and/or components of the vehicle 1500. In some examples, the infotainment SoC 1530 may be coupled to a supervisory MCU such that the GPU of the infotainment system may perform some self-driving functions in the event that the primary controller(s) 1536 (e.g., the primary and/or backup computers of the vehicle 1500) fail. In such an example, the infotainment SoC 1530 may put the vehicle 1500 into a chauffeur to safe stop mode, as described herein.

The vehicle 1500 may further include an instrument cluster 1532 (e.g., a digital dash, an electronic instrument cluster, a digital instrument panel, etc.). The instrument cluster 1532 may include a controller and/or supercomputer (e.g., a discrete controller or supercomputer). The instrument cluster 1532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1530 and the instrument cluster 1532. In other words, the instrument cluster 1532 may be included as part of the infotainment SoC 1530, or vice versa.

FIG. 15D is a system diagram for communication between cloud-based server(s) and the example autonomous vehicle 1500 of FIG. 15A, in accordance with some embodiments of the present disclosure. The system 1576 may include server(s) 1578, network(s) 1590, and vehicles, including the vehicle 1500. The server(s) 1578 may include a plurality of GPUs 1584(A)-1584(H) (collectively referred to herein as GPUs 1584), PCIe switches 1582(A)-1582(H) (collectively referred to herein as PCIe switches 1582), and/or CPUs 1580(A)-1580(B) (collectively referred to herein as CPUs 1580). The GPUs 1584, the CPUs 1580, and the PCIe switches may be interconnected with high-speed interconnects such as, for example and without limitation, NVLink interfaces 1588 developed by NVIDIA and/or PCIe connections 1586. In some examples, the GPUs 1584 are connected via NVLink and/or NVSwitch SoC and the GPUs 1584 and the PCIe switches 1582 are connected via PCIe interconnects. Although eight GPUs 1584, two CPUs 1580, and two PCIe switches are illustrated, this is not intended to be limiting. Depending on the embodiment, each of the server(s) 1578 may include any number of GPUs 1584, CPUs 1580, and/or PCIe switches. For example, the server(s) 1578 may each include eight, sixteen, thirty-two, and/or more GPUs 1584.

The server(s) 1578 may receive, over the network(s) 1590 and from the vehicles, image data representative of images showing unexpected or changed road conditions, such as recently commenced road-work. The server(s) 1578 may transmit, over the network(s) 1590 and to the vehicles, neural networks 1592, updated neural networks 1592, and/or map information 1594, including information regarding traffic and road conditions. The updates to the map information 1594 may include updates for the HD map 1522, such as information regarding construction sites, potholes, detours, flooding, and/or other obstructions. In some examples, the neural networks 1592, the updated neural networks 1592, and/or the map information 1594 may have resulted from new training and/or experiences represented in data received from any number of vehicles in the environment, and/or based on training performed at a datacenter (e.g., using the server(s) 1578 and/or other servers).

The server(s) 1578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1590, and/or the machine learning models may be used by the server(s) 1578 to remotely monitor the vehicles.

In some examples, the server(s) 1578 may receive data from the vehicles and apply the data to up-to-date real-time neural networks for real-time intelligent inferencing. The server(s) 1578 may include deep-learning supercomputers and/or dedicated AI computers powered by GPU(s) 1584, such as a DGX and DGX Station machines developed by NVIDIA. However, in some examples, the server(s) 1578 may include deep learning infrastructure that use only CPU-powered datacenters.

The deep-learning infrastructure of the server(s) 1578 may be capable of fast, real-time inferencing, and may use that capability to evaluate and verify the health of the processors, software, and/or associated hardware in the vehicle 1500. For example, the deep-learning infrastructure may receive periodic updates from the vehicle 1500, such as a sequence of images and/or objects that the vehicle 1500 has located in that sequence of images (e.g., via computer vision and/or other machine learning object classification techniques). The deep-learning infrastructure may run its own neural network to identify the objects and compare them with the objects identified by the vehicle 1500 and, if the results do not match and the infrastructure concludes that the AI in the vehicle 1500 is malfunctioning, the server(s) 1578 may transmit a signal to the vehicle 1500 instructing a fail-safe computer of the vehicle 1500 to assume control, notify the passengers, and complete a safe parking maneuver.

For inferencing, the server(s) 1578 may include the GPU(s) 1584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A system, comprising:
one or more processors to:
receive one or more data flows describing a direct memory access (DMA) data movement for transferring data using a DMA device;
generate, based at least on the one or more data flows, a hardware-level configuration of a hardware of the DMA device for the one or more data flows; and
transmit the hardware-level configuration to the DMA device for execution of the DMA data movement.

2. The system of claim 1, wherein the generating the hardware-level configuration includes generating, based at least on the one or more data flows, an intermediate configuration, and generating, based at least on the intermediate configuration, the hardware-level configuration.

3. The system of claim 1, wherein the generating the hardware-level configuration includes allocating hardware resources of the DMA device for the one or more data flows.

4. The system of claim 3, wherein the allocating the hardware resources includes allocating input buffer bandwidth and output buffer bandwidth for the one or more data flows.

5. The system of claim 1, wherein the generating the hardware-level configuration includes performing one or more optimization operations with respect to usage of bandwidth of the DMA device.

6. The system of claim 1, wherein the one or more data flows include phase descriptors for phases of the DMA data movement.

7. The system of claim 1, wherein the one or more data flows include links corresponding to sequential execution of the one or more data flows.

8. The system of claim 1, wherein the one or more data flows include a prioritization of the one or more data flows.

9. The system of claim 1, wherein the received one or more data flows each include a source and a destination, and wherein the one or more processors are to determine one or more phases for the one or more data flows and links for the one or more data flows between the one or more phases.

10. The system of claim 1, wherein the one or more processors are to:
receive one or more second data flows describing a second DMA data movement for transferring data using a second DMA device;
generate, based at least on the one or more second data flows, a second hardware-level configuration for the one or more second data flows, wherein the second hardware-level configuration corresponds to a hardware of the second DMA device; and
transmit the second hardware-level configuration to the second DMA device for execution of the second DMA data movement.

11. The system of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing large language models (LLMs);
a system for hosting one or more real-time streaming applications;
a system for performing light transport simulation;
a system for performing collaborative content creation for 3D assets; or
a system implemented at least partially using cloud computing resources.

12. A method comprising:
receiving, using one or more processors, one or more data flows describing a direct memory access (DMA) data movement for transferring data using a DMA device;
generating, using the one or more processors and based at least on the one or more data flows, a hardware-level configuration of a hardware of the DMA device for the one or more data flows; and
transmitting, using the one or more processors, the hardware-level configuration to the DMA device for execution of the DMA data movement.

13. The method of claim 12, wherein the generating the hardware-level configuration includes generating, based at least on the one or more data flows, an intermediate configuration, and generating, based at least on the intermediate configuration, the hardware-level configuration.

14. The method of claim 12, wherein the generating the hardware-level configuration includes allocating hardware resources of the DMA device for the one or more data flows.

15. The method of claim 12, wherein the generating the hardware-level configuration includes performing one or more optimization operations with respect to usage of bandwidth of the DMA device.

16. The method of claim 12, wherein the one or more data flows include phase descriptors for phases of the DMA data movement.

17. The method of claim 12, wherein the one or more data flows include links corresponding to sequential execution of the one or more data flows.

18. The method of claim 12, wherein the one or more data flows include a prioritization of the one or more data flows.

19. The method of claim 12, further comprising:
receiving, by the one or more processors, one or more second data flows describing a second DMA data movement for transferring data using a second DMA device;
generating, by the one or more processors, based at least on the one or more second data flows, a second hardware-level configuration for the one or more second data flows, wherein the second hardware-level configuration corresponds to a hardware of the second DMA device; and
transmitting, by the one or more processors, the second hardware-level configuration to the second DMA device for execution of the second DMA data movement.

20. A system on a chip comprising:
one or more direct memory access (DMA) systems; and
one or more processors to:
receive one or more data flows describing a DMA data movement for transferring data using the one or more DMA systems;
generate, based at least on the one or more data flows, a hardware-level configuration of a hardware of the one or more DMA systems for the one or more data flows; and
transmit the hardware-level configuration to the one or more DMA systems for execution of the DMA data movement.
